(19) United States
(12) Patent Application Publication
(10) Pub. No.: US 2022/0041419 A1
(43) Pub. Date: Feb. 10, 2022

(54) Novel front-mounted aerial work platform and push bumper for public works departments to assist in the installation and maintenance of street signs

(71) Applicant: Samuel Alan Ballard, Lacey, WA (US)

(72) Inventor: Samuel Alan Ballard, Lacey, WA (US)

(21) Appl. No.: 17/218,153

(22) Filed: Mar. 30, 2021

Related U.S. Application Data
(63) Continuation of application No. 63/003,058, filed on Mar. 31, 2020.

(51) Int. Cl. B66F 11/04; B60R 19/24; B25H 1/04; B60R 11/06

(52) U.S. Cl. CPC B66F 11/04; B60R 19/24; B60R 2011/004; B60R 11/06; B25H 1/04

(57) ABSTRACT

The present invention comprises a novel design for an aerial work platform that is mounted on the front of a pickup truck. This design combines the functionality of an enclosed aerial work platform with handrails and fall restraint systems while maintaining its functionality as a push bumper. In the transport position the deck folds down flat against the front of the vehicle minimizing front offset variances. When the intended to be used as an elevated work platform, integrated handrails can be deployed out from under the deck and raised and locked into position prior to use. Upon returning it to the flat transport position, the invention can be used to push straight smaller leaning street signs, push stranded vehicles out of the travel lane or be used to push foreign object debris such as animal carcasses, household debris (sofas, mattresses, large appliances etc.), tumbleweed or trees onto the shoulder of the travelled roadway. The invention may also be used as an instant work bench, capable of being outfitted with optional clips capable of receiving a variety of tools.

### FIELD OF THE INVENTION

The present invention related to a novel attachment for a utility pickup truck that enables quick and safe access to street signs for maintenance and installation.

### BACKGROUND

In the public works or roadway maintenance field there is a subset of maintenance personnel that most often work in the Traffic office or Sign Shop. This specialty subset is generally responsible for maintaining all the street and highway signs along the public right of ways in compliance with established Federal guidelines found in the Manual on Uniform Traffic Control Devices, or similar State or local regulations. Accordingly, there are many established sign heights, sign sizes and locational characterizes that are established norms but yet there is no quick, safe or convenient method of accessing the majority of all roadside signage from a regular pickup truck sized vehicle.

In particular, this inventions unique utility relates to its ability to store flat in a vertical position allowing for increased vehicular maneuverability when not in use, while being sturdy enough to be used as a push bar for straightening signposts, clearing vehicles or debris off the road such as trees or tumbleweed. While maintaining its capability of turning into an American National Standards Institute (ANSI)/Occupational Safety and Health Administration (OSHA) compliant elevated work platform capable of supporting human occupants and equipped with compliant retractable handrails and fall protection attachment points.

While the inventor admits that he knows of no directly comparable product that is designed to be as versatile as this invention two closely comparable patents are disclosed as follows:

U.S. patent application Ser. No. 15/871,557 filed by Chad Thomas Barker et al on Jan. 15, 2018 illustrates the method of installing a snowplow on a vehicle. This method is great for plowing snow or clearing and removing debris from the road such as trees or tumble weed. But not every public roads entity or authority especially those in more temperate climates such as southern border states own a snowplow, nor are there any snowplows attached to vehicles in the middle of summer due to the excess wear and tear they place on the equipment. This lack of year-round suitability increases delays in clearing roads after storms or responding to blocking vehicle issues, which do not occur on predictable schedules or seasons.

U.S. patent application Ser. No. 15/901,867 filed by Patrick Williams et al. on the 21 Feb. 2018 demonstrates the method for making a slide out platform for a van body. While not under this patent number, this manufacturer makes a secondary publicly known¹ horizontal slider work platform designed to be mounted in the back of a pickup truck specifically for use in a traffic operations/sign maintenance environment.

However, often the mounting height of the deck on the product, ends up being too high for easy access to most street signs. As the slider mechanism must be set at a height high enough in order to clear the side of the pickup truck box for this to be functional. This leads to a slide out platform deck height almost two feet higher than the Federal MUTCD² minimum height for rural signage, and the same height as the minimum height set under the same regulations for urban signage, that being 7 feet above the edge of the curb.

While there are many examples in the art for both snowplow and aerial work platforms, both serve two different needs and are not entirely interchangeable.

Therefore, there is a need for a product that possesses maximum versatility from being used to clear roads of debris, or being able to push straight leaning sign posts and then possessing the capability of being deployed as a safe platform to be stood on. All without requiring significant structural changes of adaptations thus making it a field serviceable and useable tool that allows easy access for sign maintenance, replacement or other work that needs to take place from an elevated position.

### BRIEF SUMMARY OF THE INVENTION

The Present invention comprises a novel quick connect aerial work platform and push bumper combination designed to be mounted to the front of a suitable pickup truck. The invention comprises a vehicle specific cross bolting Frame Rail Connector Bracket mounted to a Box Beam spar that separates the two male sides of the quick connect coupler that protrudes forward out below the front bumper on the mounting vehicle. Opposite the male side connector is a female side receiving assembly consisting of two plates spaced a certain distance apart with a lipped top cap and round thru cross bar. As well as various other gussets and reinforcing blocks and bars necessary to ensure strength and rigidity. This top cap and cross bar act as the hanger bracket for supporting the forward components.

Behind the female quick connect coupler is a bi-metal plate that connects the steel frame rail components to the aluminum leg assembly on the invention. At the top of the legs, set a certain distance in, on a two axis is a set of custom Deck to Leg Brackets that allow the deck plate sub frame to raise from the stowed transport vertical orientation position into the horizontal plane working position. Connected on the inside of these legs is a reinforcing bar made of the same size material as the legs in order to keep diem aligned at the base. Coming off the legs at a certain angle and with a certain specificity on either side of the legs and running down diagonal towards the horizontal reinforcing cross bar are several sections of rectangle tube providing lateral reinforcement.

On either side of the legs running out towards the edge of the frame of the deck is different form aluminum channel cut to a specific length. On the out-board end of this step outrigger channel is a custom face cut that permits the mounting of a custom Axle Block and the pass through of an Axle and an Axle Collar. The axle is made of a piece of aluminum tube of a certain length and thickness that is cross drilled in four places at perpendicular angles, and at specific locations along the length of the tube. Both the Axle Block and Axle Collar are made from a suitable reinforced pieces of contrasting colour material enabling instant recognition as to whether the axle is in the stowed/down and locked versus deployed position. These components are made from either engineering grade FDM/additive manufacturing material or via a suitably strong injection moulded process. On top and bottom of the axle is another piece of material similar in size and appearance to the step outrigger to which the axle is attached too. Next to this is a reinforcing block of appropriate size and strength to prevent deflection of the step when used. The face of the step is made from a section of compatible tread bright diamond plate and attached in a certain manner to prevent accidental slipping of the operator's foot.

On top of the legs are custom axle brackets that join the Deck superstructure to the Legs. Below this superstructure is a specific gap that allows all the necessary components and hardware to be mounted for a fully retractable, collapsible Telescoping Handrail System that stores under the deck when not in use, but that can be maneuvered while connected out from under the deck, locked into the deck and then telescoped out providing an ANSI/OSHA compliant hand rail. The Handrail is made of four sections of nesting aluminum tubing, with three sections of horizontal mid span tubing and a continuous span top bar. To secure the handrail into the upper locked or lowered position there are a number of integral bolt action locking pins that can be advanced thru corresponding holes to hold open or closed a section of handrail. This can also be done via an external mounted locking pin that like its internal counterpart may be actuated via mechanical (human), electromechanical or electromagnetic methods.

Attached to the ends of the lateral handrail cross bars are a series of custom printed reinforced FDM/injection moulded components that are designed to hold the endcap handrail components. The end cap handrail components are comprised of a custom FDM printed or injection moulded latch, that attaches to the rear deployed handrail system. Along with a custom eye bracket that is attached to a section of round tube of a certain length that is attached to the custom FMD latch component. Some distance down the length of the front handrail horizontal tubes are a series of custom FDM or injection moulded brackets that can move laterally while clipping the end cap handrail into a stowed position against the front horizontal railing bars when not in use.

Attached to the lowest level of the telescoping handrail tubing is ANSI compliant Kickplate made of a perforated aluminum perforated plate that will enable air flow thru it while preventing larger objects such as an operator's foot or other such object from falling forwards thru and under the deck. This Kickplate of specific size is reinforced by a solid piece of flat aluminum bar of specific size and thickness thus enabling the thru bolting of the Kickplate into the Kickplate Slider Brackets. The Kickplate Slider Brackets are made of a strong but durable plastic material possessing a relatively high strength to low friction component. These brackets are also thru drilled enabling the bolting and securing of the Kickplate to diem.

Attached to the bottom of the Kickplate and located directly centered on the center of each vertical handrail section are a series aluminum pin and plate blocks that are drilled and tapped enabling diem to be bolted to the back of the kick plate slider brackets. These blocks and pins are of a certain size and positioning that enables diem to be easily slid into and out of a female receiving collar embedded into the Deck Superstructure, thus allowing for an easy and secure method of securing the handrail in the vertical position.

Below the Deck Superstructure and attached to the bottom of the handrail components is a system designed to enable the easy stowage and operation of the Handrail Assembly. This consists of a channel rabbited into a piece of aluminum tube stock of set size and length allowing for the free movement of a slider shuttle to run the entirety of the channel. On either exterior end is a custom Digitally printed/additive manufactured or injection molded plastic end cap that's secured via physical means and compressive force to the slider block. In the center of the deck between the two slider channels is a second and different type of end cap, again made of the same type in a similar manner of material is a center block that acts as an internal endcap and is secured via a physical compressive force means. The slider shuttle Connected to the slider shuttle that is made of an appropriately proper form of plastic via either the FDM of injection moulding process is an integrated metal axle with an appropriately sized female relief On the male side of the bracket are two bolt and nut holes for securing the lower handrail mounting bracket to the slider shuttle via a correctly sized and placed male elongation capable of supporting the stresses imposed into the handrail thru various operational conditions, which is in turn attached into the vertical metal handrail components.

The deck frame being made of a certain size and thickness of aluminum tube being reinforced by smaller pieces of tube is connected to the legs via the custom axle brackets and provides the primary surface for standing on or pushing with. Attached to the custom brackets is a spring-loaded bolt-action style locking pin that secures the deck into to either a fully vertical or horizontal position by fully going thru both custom axle brackets and the entirety of the leg frame. This system may also be augmented via the use of a comprehensive application of electronic screw jacks attached in a certain manner that would enable the unlocking, raising or lowering of the deck and resecuring of the locking pins via the application of an electronic relay. Set into the top of the leg frame is either a custom FDM or injection moulded plastic spacer block that properly transfers the rotational, compressive and lateral loads further into the legs and prevents frame deformation.

### BRIEF DESCRIPTION OF THE SEVERAL VIEWS OF THE DRAWINGS

The embodiments of the invention are described in the ensuing systematic order in the following list of illustrative figures that are attached to the drawings, in which like references may indicate similar elements and in which:

FIG. 1—FIG. 1 depicts an isometric view of the entirety of the unique invention as described from an elevated position, illustrating the functionality of the deck in a deployed position with raised handrails, and the various embodiments described herein.

FIG. 2—FIG. 2 shows a front on perspective of the deck superstructure and the various embodiments described herein.

FIG. 3—FIG. 3 shows an isometric perspective of FIG. 2 with the deck plate removed from view so that the superstructure can be seen easier and the various embodiments described herein.

FIG. 4—FIG. 4 illustrates a front perspective of the invention with the handrails collapsed, stowed and deck raised or deployed. In this perspective the grill of the vehicle would be behind the drawing. Also shown are the legs, step assembly's and deck locking pins and the various embodiments described herein.

FIG. 5—Figure S shows a side on view of the model with the handrails folded, collapsed, stowed and deck raised or deployed. In this perspective the front of the vehicle would be right the drawing. Also shown is a side view of the legs, steps and quick connect truck mounting assembly with the male and female couples un-coupled for illustration, and the various embodiments described herein.

FIG. 6—FIG. 6 shows the unique invention described herein from a top down perspective. Shown is the deck in a folded or stowed position along with the telescoped handrails, lower leg superstructure, deck locking pin assembly's and the un-coupled truck mounting bracket assemblies along with the various embodiments described herein.

FIG. 7—FIG. 7 shows the unique invention from a side on perspective illustrating the position of the handrails whence telescoped in, collapsed, and stowed alongside of the deck when it is stowed for transport. Also shown are the deck to leg brackets, step assembly, deck locking pin assembly and the un-coupled truck mounting bracket assemblies along with the various embodiments described herein.

FIG. 8—FIG. 8 shows the side on perspective of the telescoped handrail assembly with the kick plate raised and handrail deck locking pin slidden up out of the deck. Also shown are the handrail slider bracket fitting, slider bracket shuttle and a longitudinal stringer of the deck superstructure, along with the various embodiments described herein.

FIG. 9—FIG. 9 shows a side on expanded view of the lower section of the vertical handrail tubing, Kickplate, and Kickplate Slider Brackets with associated Hardware. Along with the Handrail Slider Assembly including the Fitting, Shuttle, End Caps and Bracket, along with the various embodiments described herein.

FIG. 10—FIG. 10 shows the same elements as described in FIG. 9 but from anisometric view for clarity. These said pieces are the lower section of the vertical handrail tubing, Kickplate, and Kickplate Slider Brackets with associated Hardware. Along with the Handrail Slider Assembly including the Fitting, Shuttle, End Caps and Bracket, along with the various embodiments described herein.

FIG. 11—FIG. 11 is an isometric drawing view of the handrail and deck superstructure section of the unique design showing the deployment and unfolding of the front telescoping handrail and the locking in place of the handrail deck locking pin as attached to the lower telescoping handrail section. This drawing also shows the un-telescoped rear handrail section on the back of the deck, the transverse endcap handrail sections in the stowed position against the front handrail along with the associated securement clips, including the horizontal handrail locking pin assemblies, occupant tie off brackets and various other embodiments described herein.

FIG. 12—FIG. 12 is an isometric drawing showing a more detailed view of the handrail in the un-telescoped deployed position with the transverse endcap handrails rotated out into the deployed position and locked into place on the other longitudinal handrail section, along with other various embodiments described herein.

FIG. 13—FIG. 13 is a frontal plane view of the unique design showing the deck in the raised or deployed position with the handrail assemblies removed for clarity. This drawing shows the steps in the down and locked outwards rotated position. Along with a better view of various items such as the deck superstructure, the handrail slider brackets and end caps, the legs assembly, partial rear view of the backer plate of the female section of the truck mounting bracket assemblies along with the various embodiments described herein.

FIG. 14—FIG. 14 shows a side view of the unique design showing the deck in the raised or deployed position with the handrail assemblies removed for clarity. This drawings shows the transverse end of the outer deck superstructure, the deck to leg rotator brackets, the rotator axle and busing, deck locking pin assembly, leg top cap with bolts, leg assembly with the step assembly rotated in the down and locked position. Along with the Truck Mounting Bracket Assembly showing the connection of the male and female sections and their associated handwear including the various embodiments described herein.

FIG. 15—FIG. 15 is an isometric representation of FIGS. 13 & 14 and all the items contained there within along with the handrail deck locking pin assembly slider bodies including the various embodiments described herein.

FIG. 16—FIG. 16 is an isometric expanded view of one of the legs, the top and bottom end caps, the design of the deck to leg rotator bracket and the deck locking pin assembly, along with various pieces of hardware and the various embodiments described herein

FIG. 17—FIG. 17 drawing shows an exploded view of the makeup of one of the deck locking pin assemblies and the various embodiments described herein.

FIG. 18—FIG. 18 is an enlarged drawing showing the completed deck locking pin assembly dial was expounded in FIG. 17 and the slider channel for actuating the manual locking pin and the various embodiments described herein.

FIG. 19—FIG. 19 shows the step assembly rotated in the down and locked position in a negative isometric position from below to provide clarity on the design and the various embodiments described herein.

FIG. 20—FIG. 20 shows an enlarged frontal view of the step assembly for clarity in the rotated down and locked position and the various embodiments described herein.

FIG. 21—FIG. 21 shows an enlarged side view of the step assembly for clarity in the rotated down and locked position including the pin hole in the lower level step for receiving the rear telescoping support bracket for removing and self-supporting the deck assembly from the front of a vehicle (see FIG. 51) and the various embodiments described herein.

FIG. 22—FIG. 22 shows an isometric cut through of a step rotator block seen in FIG. 22. This cut through shows the pass-through channel and the locking collar blocks that secure the step in either the up and stowed or down locked and rotated position, and the various embodiments described herein.

FIG. 23—FIG. 23 illustrates an expanded view of the lower half of the step assembly with the top step omitted for clarity but attached in a like manner. This figure shows the step rotator locking hub positioned above and rotated 90 degrees off position to show the recessed cut out as illustrated in FIG. 22. Followed by the Step Outrigger and the location of the face cuts and tapped holes necessary for securing the Rotator Block to the step outrigger while allowing clearance for the Axle and Axle Collar to clear through. Bellow this is the lower step and below that is the lower Step Reinforcing Block and the various embodiments described herein.

FIG. 24—FIG. 24 shows an isometric cut through of the Axle and Axle Collar as illustrated in FIG. 23 including the corresponding thru drilling and tapping enabling the axle collar to be bolted on and the various embodiments described herein.

FIG. 25—FIG. 25 shows an isometric enlarged section of handrail containing the lower three sections of telescoping handrail and their associated horizontal cross bars. On the horizontal cross bars are a series of clips (FIGS. 26 & 27) that are used to secure the Transverse End Cap Handrails to the main longitudinal handrails when in the stowed position and the various embodiments described herein.

FIG. 26—FIG. 26 drawings shows the side on profile of a custom clip designed to snap on over the horizontal handrail bars mentioned in FIG. 25 and then pinch the connecting shaft seen in FIG. 45 holding it securely in position for transport and the various embodiments described herein.

FIG. 27—FIG. 27 shows an isometric profile of the handrail securement clip first mentioned in FIG. 25 for context and the various embodiments described herein.

FIG. 28—FIG. 28 illustrates a section of horizontal handrail as seen in FIG. 11 with the rest omitted for clarity and shows the placement of two different options for Tie Off Brackets mounted on the horizontal intermediate piece and the various embodiments described herein.

FIG. 29—FIG. 29 shows a top down plan view of the two types of Tie Off Brackets mounted on a section of horizontal handrail as seen in FIG. 11 and referenced in the above description for FIG. 28, with the rest of the design omitted for clarity and the various embodiments described herein.

FIG. 30—FIG. 30 shows a frontal aspect view of the two types of Tie Off Brackets mounted on a section of horizontal handrail as seen in FIG. 11 and referenced in the above description for FIG. 28, with the rest of the design omitted for clarity. In this drawing we can see that both designs share the same size, frontal aspect and overall appearance and the various embodiments described herein.

FIG. 31—FIG. 31 shows a top down view of the removable clip-on tie off bracket and shows both the tie off body and recessed bolts embedded in the top along with the various embodiments described herein.

FIG. 32—FIG. 32 shows a rear aspect view of the removable clip-on tie off bracket. In this image the tops of the clip-on ramps can be seen in by the presence of the dark horizontal line, along with the body of the two bolts shown by the positioning of the two vertical cylinders, and the various embodiments described herein.

FIG. 33—FIG. 33 shows an isometric perspective of the removable clip-on tie off bracket and is useful for illustrating the relationship of the feeder ramps in relation to the securement bolts and overall shape, composure of the bracket and the various embodiments described herein.

FIG. 34—FIG. 34 shows a top down perspective of the slip-on tie off bracket and the various embodiments described herein.

FIG. 35—FIG. 35 shows a rear perspective of the back of the slip-on tie off bracket and the various embodiments described herein.

FIG. 36—FIG. 36 shows an isometric view of the slip-on tie off bracket and the various embodiments described herein.

FIG. 37—FIG. 37 shows a frontal perspective of an end section of longitudinal handrail as seen in FIG. 11 with various other components omitted for clarity and the various embodiments described herein.

FIG. 38—FIG. 38 shows a transverse end side view of the telescoping handrail sections as seen in FIG. 37 and the various embodiments described herein.

FIG. 39—FIG. 39 shows a top down perspective view of the telescoping handrail section and demonstrates the tight tolerances of the nesting telescoping sections and the various embodiments described herein.

FIG. 40—FIG. 40 shows a face on view of a cut out section of vertical and horizontal handrail. This drawing shows the size and shape of the facial relief cuts that allow the Bolt Action Handrail Locking Pin Assembly to work along with the various embodiments described herein.

FIG. 41—FIG. 41 shows an isometric exploded view of the Bolt Action Handrail Locking Pin Assembly and the various embodiments described therein.

FIG. 42—FIG. 42 shows a partial side on view of the Truck Mounting Bracket Assembly and the various embodiments described herein.

FIG. 43—FIG. 43 references FIG. 42 and shows a partial exploded side on view of the Truck Mounting Bracket Assembly and the various embodiments described herein.

FIG. 44—FIG. 44 references FIG. 43 and shows a partial exploded view of the Truck Mounting Bracket Assembly from the underside and the various embodiments described herein.

FIG. 45—FIG. 45 shows the transverse end cap handrail assembly in an isometric view as referenced from FIG. 11 and the various embodiments described herein.

FIG. 46—FIG. 46 referenced from FIG. 45 shows a transverse side on viewpoint and shows the various features of the transverse end cap handrail assembly and the various embodiments described herein.

FIG. 47—FIG. 47 references FIG. 46 rotated right 90 degrees and shown from atop down perspective and shows the various features of the Transverse End Cap Handrail Assembly and the various embodiments described herein.

FIG. 48—FIG. 48 is a cross section referenced from FIG. 47 section C-C and shows the positioning of the captive bolt and internal compression spring that are embedded inside the custom FDM latch system and shows the various features of said system and the various embodiments described herein.

FIG. 49—FIG. 49 is a cross section referenced from FIG. 47 section D-D and shows both the hidden bolts that secure the custom FDM eyebolt to the round tube but also the hidden bolt that attached the end cap attachment bracket to the handrail stubs as seen in FIG. 37 while showing the various features of the Transverse End Cap Handrail Assembly and the various embodiments described herein.

FIG. 50—FIG. 50 is an inside view 180 degrees opposite to that found in RG FIG. 46 and shows various features of the Transverse End Cap Handrail Assembly not yet illustrated and the various embodiments described herein.

FIG. 51—FIG. 51 shows the design from the transverse end side view and shows the deck in a collapsed of stowed position along with the step and leg assemblies and the truck mounting bracket assemblies along with the front and rear mounted telescoping support leg sections brackets and the various embodiments described herein.

FIG. 52—FIG. 52 shows the front and rear mounted telescoping leg assemblies in the same orientation and position as seen in FIG. 51 and the various embodiments described herein.

FIG. 53—FIG. 53 shows the telescoping support legs as seen in FIG. 51 from an outside perspective with the back of the support bracket in view and denotes the internal characteristics via dashed lines and the various embodiments described herein.

FIG. 54—FIG. 54 references FIG. 52 and shows the unique design in front isometric looking back at the deck in the foreground and looking over the deck to see the male side of the Truck Mounting Bracket Assembly and where the front grille of the mounting vehicle would be, and provides reference for attachment or placement of the telescoping legs into the Handrail Locking Pin Sleeves attached to the face of the deck superstructure and the various embodiments described herein.

FIG. 55—FIG. 55 references FIG. 51 and the various embodiments described herein, and in the same viewing aspect show the positioning of the telescoping support legs before being attached to the deck and step assemblies and the various embodiments described herein.

FIG. 56—FIG. 56 references FIGS. 54 and 55 and shows the telescoping legs in an isometric position before being attached to the deck and leg assemblies and the various embodiments described herein.

### DETAILED DESCRIPTION OF THE INVENTION

The terminology used herein in order to describe the particular embodiments and design of the invention are not intended to be limiting of the invention. As used herein the terms “and/or” may include any combination of one or more of the possible associated listed items. As used herein the singular indefinite articles “a/an” or the definite article “the” may be used as plural articles as well as singular articles, unless contextually its use is definitive. Furthermore, the phrases “comprise” and/or “comprising” may be used to specify the presence of stated, elements, components, features, operations, or steps but do not in any form imply a state of singularity.

Unless specifically stated all terms will be used herein in a manner that would be commonly understood by one having ordinary skill in the area to which this invention belongs, and furthermore consistent with standard dictionary definitions, in a manner that is not overly formal unless necessary to bring clarity of the concept and invention.

In describing the invention it shall be understood the a inventor has laid out the best method envisioned in order to describe the functionality and techniques used to construct this unique design And that there are a number steps and techniques disclosed, but that for the sake of clarity only one method of construction will be illustrated notwithstanding or diminishing the possibilities of multiple combinations that would make this an overly long and complicated document. None the less, the entirety of these combinations shall be entirely within the scope of this unique invention and its claims.

Also Since there are many components to this design that may be repeated up to roughly 40 times per section or assembly, for the sake or brevity, unless a specific component is called out by its subsidiary identifier such as 99AB all non-position specific or critical for understanding components may be abbreviated to the general component identifier such as 99 after once initially having listed the range of possible options in the following format 99A-AN.

A new aerial work platform and combination push bumper is discussed herein. The following narrative for purpose of explanation provide numerous specific details that are set for in an order to provide a thorough understanding of the present invention so that it will be evident to one skilled in the art of the present invention may not be recreated without these specific details.

Therefore, the present narrative and disclosure is to be considered an illustrative example of the specific new invention and not limiting it by the specific embodied description that follows.

Therefore, the present invention will now be described by referring the included drawings that represent specific embodiments.

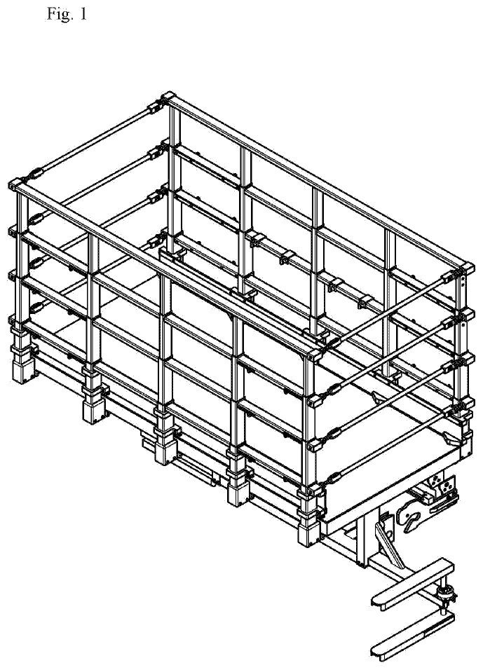

FIG. 1 depicts the corporate invention in a whole in order to get an overview of the invention and as a point of reference and is intended to be mounted on the front of a vehicle.

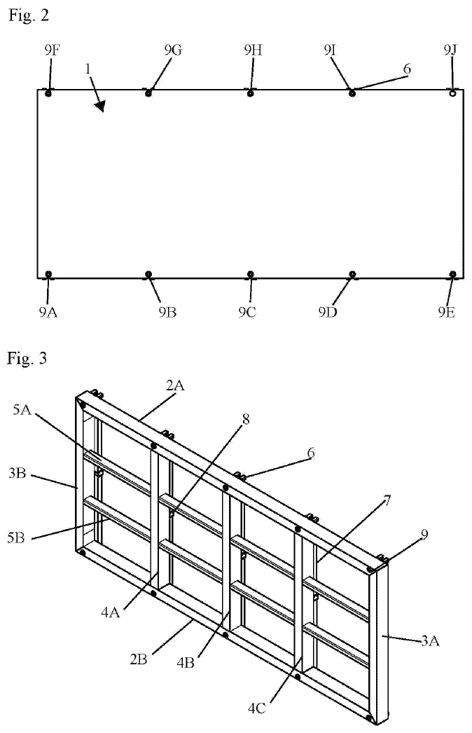

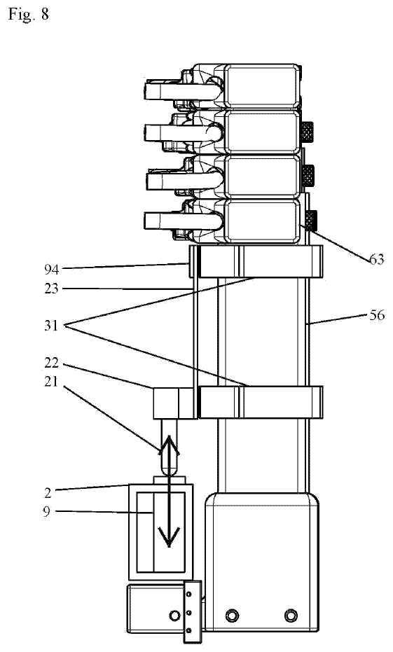

FIG. 2 is a front on view of the Deck as it would be found in either the stowed or vertical position for transport. 1 represents the Deck Plate being some form of either expanded aluminum sheeting or a custom cut design capable of providing ample foot traction, airflow structural rigidity is attached to the deck superstructure found in FIG. 3, via the means of either flush mounting hardware attachments or in this case seam welding where necessary. Along the edges of the deck are 10 holes, with S along each longitudinal edge spaced a certain distance either side of the center holes (9C & 9H) respectively. These holes are drilled completely through the Deck superstructure and then have a series of Handrail Locking Sleeves (9A-J) inserted and then welded to the deck with a flush joint on the bottom of the Deck and slight protrusion on the front & top specifically sized in order to compensate for the thickness of the deck materials. These sleeves are of a certain size and thickness that they are capable of acting a handrail securement device to prevent an average sized person from deflecting the assembly more than I″ should they either lean on or fall over the edge while attached to an Occupational Safety and Health Administration (O.S.H.A.) compliant fall protection device. Therefore, these Sleeves have a tubular shape with an inner diameter close to that of the locking pin 22 seen in FIG. 8. Note: Sleeve 9J is not shown on the plans in order to show the difference in size between the inner diameter size of the Sleeve and that of the outer diameter of the corresponding sleeve.

FIG. 3 shows an isometric perspective from the front of the Deck superstructure but unlike FIG. 2 the Deck Plate has been removed. 2A&B are the Longitudinal Stringers that run across the length of the Deck—in this perspective, from the drivers' side of the vehicle on the right of the deck to the passenger side on the left of the deck. The Longitudinal Stringers like all the deck superstructure components in this model are extruded aluminum tubing. However, it is possible to achieve significant cost or material saving by manufacturing with either steel, other alloy metals or composite materials such as fiberglass or carbon fiber and should therefore be consider as part of the design and subsequent claim. The Longitudinal Stingers vary in length from 48″ to 108″ and have mitered corners at 45 degrees on either end, and are set parallel to each other at a distance ranging from 18″ to 56″ apart. Between the Longitudinal Stringers at the perimeter of the deck super structure are 2 Transverse End Cap Stringers 3A&B that are being made of the same size and thickness material as the previous ones, and are mitered at 45 degrees on either end to make a tight corner and then welded or joined as necessary on all sides making one singular piece. After this the inside space is subdivided into 4 or more parts as necessary working out from the center of the longitudinal axis and then marking the locations for the centers of the Inside Transverse Stringers. These Inside Transverse Stringers 4A-C are made of the same size, shape and thickness of material as the perimeter frame and are securely welded or joined in such a manner that they form one complete piece. Along the center line of each of these Inside Transverse Stringers along the top of the Longitudinal Stringers, holes are drilled I″ in diameter and set back the thickness of the material from the outside edge of the deck. Into these holes, Handrail Locking Pin Sleeves 9A-J are inserted that are sized accordingly and thoroughly fastened to the Deck superstructure in such a manner that they are bonded and prevented from moving. Then, the transverse space in between the Longitudinal Stringers is subdivided again into a minimum of two sections, and an Intermediate Longitudinal Stringer is inserted see 5A & B. These Intermediate Longitudinal Stingers are made of expanded aluminum rectangle tubing and are made of slightly smaller and lighter material than is found in the perimeter deck superstructure. These pieces can be either individually fitted in-between the Transverse Stringers and butt-welded or joined at each end or they may be a continuous piece that is notched to fit in corresponding notches inside of the Inside Transverse Stringers 4 so that when they are welded or joined to the abutting materials in such a manner that they sit flush with the top of the Deck superstructure and do not protrude above or below unnecessarily. Attached to the back, or bottom of the Deck superstructure are a series of aluminum tubes either square or rectangular in fashion. These Slider Bracket Tubes 7 are fastened to the bottom of the Deck superstructure in such a manner that they cannot move and make up the backbone of the said Handrail Slider Bracket Assembly in that they allow the Handrail Slider Shuttle and corresponding Handrail Fitting to slide back and forward without unwanted movement.

These tubes see FIGS. 9 & 10 and have a rabbited face cut at least 0.5″ in width running the entire top (opposite of the bottom which is fastened to the bottom of the deck superstructure) permitting the handrail fitting to travel through the face un-obstructed. In between these Slider Bracket Tubes we find a plastic component that acts as the Slider Bracket Mid Stops 8 for each tube and limit the travel of the Slider Bracket Shuttle 95 see FIG. 10. At the opposite outside edges of the Slider Bracket Tubes 7 we find the Slider Bracket Endcaps 6. Again these components are made of plastic or metal, and maybe either additive in nature, injection molded, composite or milled from appropriate metals in order to prevent the Slider Bracket Shuttle from exiting the tube while permitting a full 90 degree range of motion for the attached Handrail Fitting. See: FIGS. 10 & 11.

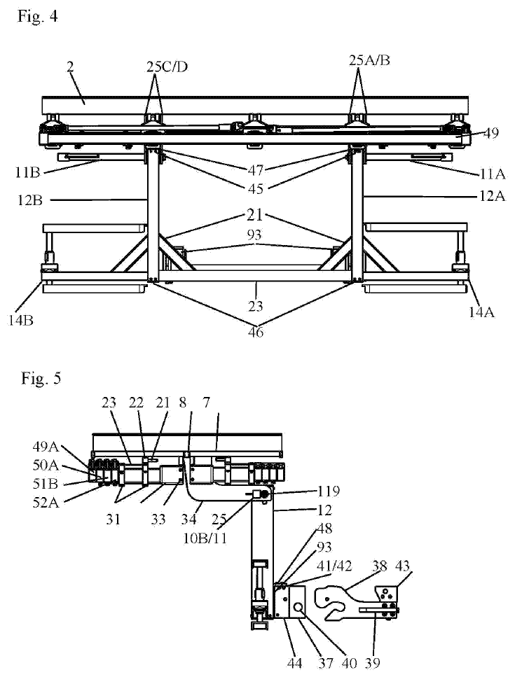

Continuing, FIG. 4 presents a frontal aspect view of the unique design with the Deck, with the term “Deck” referring to the Deck Superstructure, Frame, Deck Plate, and Hand Rail Slider Tubes or anything logically associated or attached to it as indicated in the drawings (2B) raised into a horizontal or deployed profile with the top of the handrails visible in the telescoped and stowed position under the Deck. Below the Deck and Handrails, we can see the Leg and Step Assemblies and the back side of the Bi-Metal Plate 93 attached to both the Truck Mounting Bracket Assembly and the lower parts of the Leg Assembly.

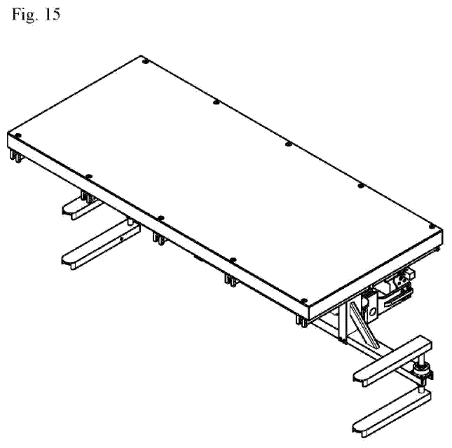

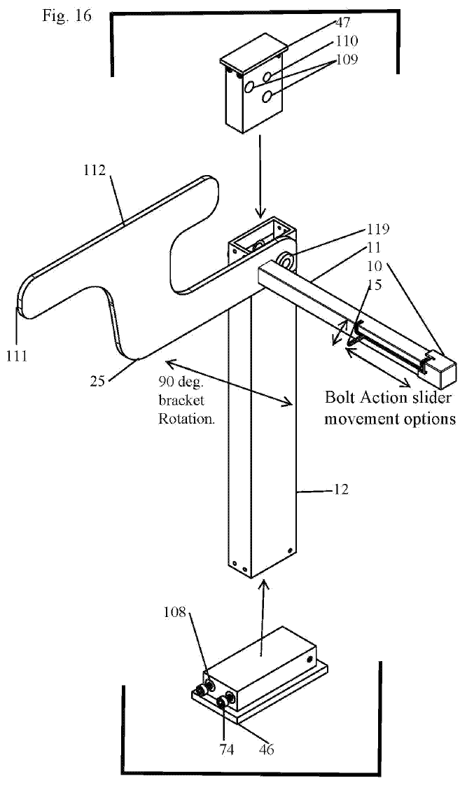

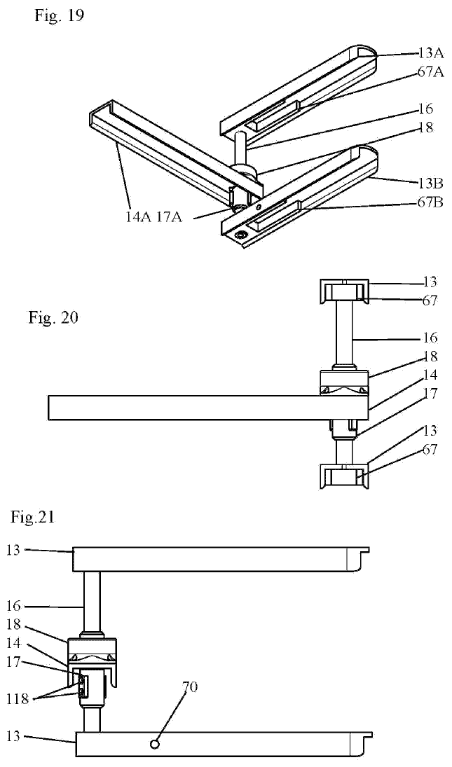

Rising above and connected to both the Legs and Transverse Stringers we can see the front view of the Deck to Leg Brackets 25A-D see FIG. 16 for a more complete view. Attached to the inside faces on the Legs 12A & B and Deck to Leg Brackets 25 where there is a possibility of surfaces rubbing together, non-friction UHMW tape is applied to both surfaces. Attached to the outside Deck to Leg Brackets 25 are the Deck Locking Pin Assemblies HA 11A & B. These assemblies allow a pin to be inserted thru both Deck to LegBrackets and the corresponding Leg in the middle (See FIGS. 16-18). The Legs 12 being identical in size, shape and material are made from a section of rectangle aluminum tube widia minimum cross-sectional thickness of 0.375 inch with a variable length between 12″ and 60″. On the narrow faces 4 holes are thru drilled, approximately 1 inch in from each side and one-half inch up from the edge. These holes permit screws 45A-EC, of a certain size to be inserted in and anchor the Leg Top Cap 47A & B and Bottom Caps 46A & B into place (see FIG. 16 for more detail). At the bottom of the Legs there is a Horizontal Cross Bar 23 that is the same size, shape, and thickness as the Legs. This Horizontal Cross Bar varies between 18″ and 48″ in length and is securely welded or joined on all sides to the legs and is mounted flush with the bottom of the Legs 12. On the outside of the Legs 12 opposite the Horizontal Cross Bar 23 are mounted the Step Outriggers 14A & B see FIG. 19-24 for more detail. The Step Outriggers are made of Aluminum C channel and have a minimum thickness of 0.375 inch, with a variable face width of 2″-6″ and variable length of 8″-36″. Coming off from the Legs 12 at a 45-degree angle and running down to both the Step Outriggers 14 and Horizontal Cross Bar 23 simultaneously are 4 Reinforcing Gussets 21A-D. These reinforcing gussets being made of the same size, shape and thickness of material as the Intermediate Longitudinal Stringers 5. found in FIG. 3. And are fully welded or affixed to all adjoining faces in such a manner dial they become as one piece. These Reinforcing Gussets have an outside minimum length edge between the angled cut of 6″ with a maximum length of 14″ and are set towards the back half of the adjoining faces. On the back side of either Legs 12 the Bi-Metal Backer Plates 93A & B are visible that secure the lower Leg Assembly to the back of Female Coupler FIG. 43 that is part of the Truck Mounting Bracket Assembly. This bracket is secured to the Legs 12 via either a mechanical fixture, weld or a combination of features dial create a strong and rigid joint and is 6″ squared.

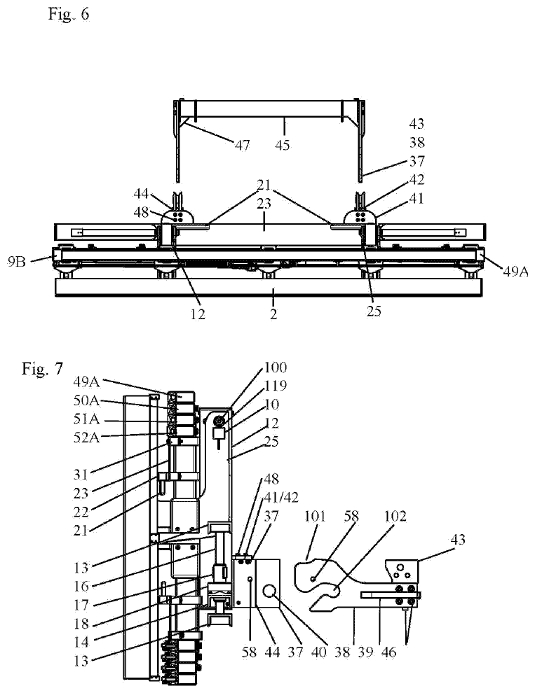

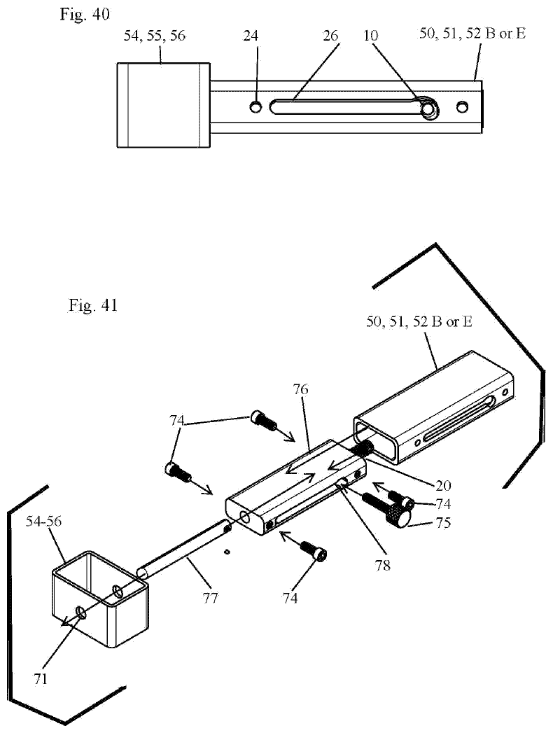

FIG. 5 provides a transverse side on view of the design. From this perspective we can see the Handrail Assembly which consists of 33, 34, 49A, 50A, 51A, 52A, along with the Handrail Locking Pin Assembly 21, 22, 23, 31 telescoped in and nested in the stowed position under the deck. The Handrail and Handrail Locking Pin Assemblies will be covered in greater detail in FIGS. 40 & 41. At the bottom of the Leg 12 we can see the Step Assembly in the up and stowed position sitting parallel to the Step Outrigger 14 first mentioned in FIG. 4. see FIG. 19-24 for more detail. To the right, at the Back of the Leg 12, the un-coupled Truck Mounting Bracket Assembly can be seen. The Female Coupler consists of 93, 41, 42, 44, 40, 37 with the Male Coupler consisting of 38, 39, 43. Truck Mounting Bracket Assembly specific details can be found in FIGS. 6, 7 and 42-44.

Referring now to FIG. 6 that this profile is taken from a atop down position above the unique invention. From this position we can see the edge of the Deck Plate 1, the Longitudinal Stringer 2, as well as the Top Handrail and End Caps being 49A-D being right behind. Again, as well we can see the Deck Locking Pin Assemblies 11 attached to the outside edges of the Deck to Leg Brackets 25. Again, we can see that the Step Assembly is still running parallel to the deck with only the Top Steps 13A & C being visible at this time is the Horizontal Cross Bar 23 at the bottom of the Legs and Reinforcing Gussets 21B & C. Behind the Legs 12 is the Truck Mounting Bracket Assembly. The Female Coupler which is connected to the Legs is the same for either side. At the top we have the Top Cap 41 which is secured via 4 bolts 48 to the Feeder Ramps 37A & B. The Top Cap is about 3″×6″ with rounded corners and sits aside the Bi-Metal Bracket 93 against the Legs 12. Below the Top Cap is the Lipping Ramp 42 that is edge welded to the Top cap and helps keep the Male Side Connector Bracket 38A & B in-position. Welded to the Bi-Metal plate 93 are two steel feeder ramps 37 that are mirror images of each other. They are about 6″ squared and feature a beveled edge to help guide the male end into a coupling position. These Feeder Ramps 37 are secured via welding in such a manner that the do not interfere with the positioning of other pieces, 38, 41, 42, 44 but are close enough together to prevent rack or wobble in the coupled joint but loose enough to prevent easy coupling of the male and female components. On either side of the Feeder Ramps 37 are two L Brackets 44A & B that are welded to both the Bi-Metal Plate 93 and the Feeder Ramps providing reinforcement for the bracket. The Male Side Connector Bracket 38 is between 12″ and 30″ long, at least 8″ high and runs all the way back to the Frame Rail Box Beam 45 at the back. On the outside edges of Male Side Connector Brackets 38 are Reinforcing Bars 39A & B that are made of some I″ by steel bar and are securely welded on all sides to the Male Side Connector Brackets. Running Parallel to the Male Side Connector Brackets are a pair of Truck Frame Rail Connector Brackets 43A-D These Frame Rail Brackets are Vehicle Specific and will change styles and shapes between manufacturers, models, and years. These Brackets 43 are made out of 0.25″ thick steel bar 8″ wide and are securely welded to the top of the Box Beam 45. Also attaching the Box Beam 45 to the Male Side Connector Bracket 38A & B are 4 support Triangles 47 with two on each end and each vertical edge they are securely welded to both pieces.

FIG. 7 shows the unique invention from a side on perspective illustrating the position of the Handrail Assembly 33, 34, 49A, 50A, 51A, 52A whence telescoped in, along with the Handrail Locking Pin Assembly 21, 22, 23, 31 as it would be in the stowed for transport position. Running behind the Handrail Assembly, from the Deck 1, 3 to Leg 12 the Deck to Leg Brackets 25 can be seen in the downwards rotated position. At the top end of this bracket the End Cap 10A of the Deck Locking Pin Assembly can be seen right below the Axle 100 and Axle Bushing 119. The Axle Hole thru both the Deck to Leg Brackets 25 and Legs 12 is a 25 mm thru hole. The Axle is 19 mm in diameter and is made of a form of hardened steel and is designed to accept the thrust and rotational loads imposed. The Axle Bushing 9 is made from a polymer material via either a FDM process, extrusion, or appropriate milling process, in order to create a bushing strong enough to perform without significant elongation or deformation while maintain a low surface p value. At the bottom of the Legs 12 the Step Assembly consisting of 13, 14, 16, 17, 18 can be seen in the stowed and locked position sitting inline and perpendicular to the Deck Superstructure: see FIGS. 19-24 for more detail. To the right of the Step Assembly we can see the Truck Bracket Mounting Assembly in detail. Attached to the back of the Leg 12 we can see the Bi-Metal Backer Plate 93, followed by the L Bracket 44 and outside Feeder Ramp 37A. At the top of the L brackets there are two holes drilled and tapped 44 through both L brackets 44, Both Feeder Ramps 37 and the Lipping Ramp in the Middle 42 that is used to provide additional securement to the Top Cap/Lipping Ramp group. At some point off center on the L Bracket and again drilled through both L brackets 44, Both Feeder Ramps 37 a hole exists for a cotter pin 58 to be installed later to prevent the male and female couplers from accidental detachment while in travel. Approximately ¼ way back from the leading bevelled edge and about ⅓^{rd} of the way up from the bottom edge on the Feeder Ramps 37 is a 1.5″ hole designed to receive a 1.5″ Loading Pin 40. Further to the right again we can see the Male Side Connector Bracket 38A showing the outline of the bracket, and in particular the Inverse Lipping Ramp 101 cut to match the profiled Lipping Ramp 42 on the Female side, with the corresponding Cotter Pin Hole 58 just below. In the middle we can see the Loading Pin Cut Out feature 102 which ramps up and over the Loading Pin 40 providing three axis securements. Further right again and sitting on top of the Male Side Connector Bracket 38A. We can see a profile view of the Frame Rail Connector Brackets 43 used to attach the male side of the Truck Mounting Bracket Assembly to the Front Frame rail of the mating vehicle behind the front bumper.

This feature is vehicle, manufacture, and model specific. Running perpendicular to the Deck Superstructure from the back of the Male Side Connector Bracket 38 forward we can see the Reinforcing Bar 39. The reinforcing bar is securely fastened of joined to the Male Side Connector Bracket in such a fashion that it provided a rigidity to the structure and diminishes any flex in the bracket. At the back end of the Male Side Connector Bracket 38 and on either side of the reinforcing Bar and on the right edge and bottom edge behind the Connector bracket on the Box Beam 45 (not visible) there are 6 bolts 46 that are used to secure the Frame Rail 43 & Box Beam Assembly together during fitment.

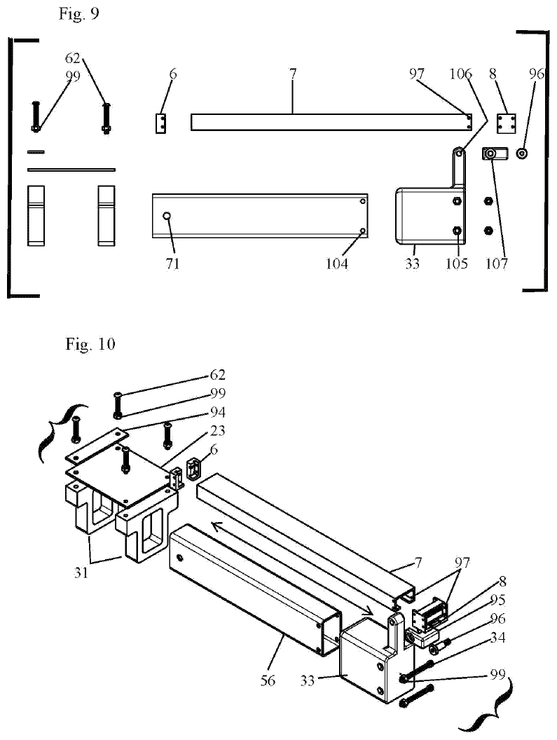

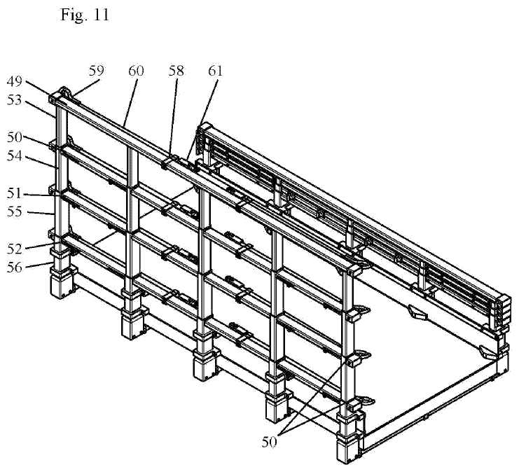

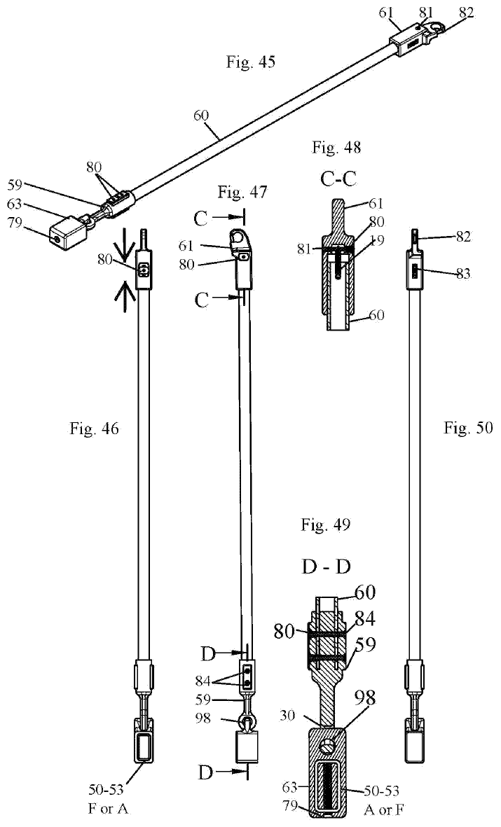

FIG. 8 Shows a transverse side on perspective of the telescoped handrail assembly with the kick plate raised and handrail deck locking pin slidden up out of the deck. On the left side of the drawing one of the Longitudinal Stringers 2B is shown with the Handrail Locking Sleeves 9 inserted into the stringer. Above the Handrail Locking Pin 22 which can be seen to be attached to the Handrail Locking Pin Block 21. The Handrail Locking Pin 22 is made from 0.5″ aluminum round bar and is press fit into a corresponding hole on the bottom side of the Handrail Locking Pin Block 21 and welded to ensure no movement occurs. The arrows show the possible range of linear motion that is available. To the right of the Handrail Locking Pin Block the Deck Kickplate 23A & B can be seen. The Kickplate is made of expanded metal grating and is at a minimum of 4″ tall and varies in length between 48 and 108″ long running the full length of the deck. At the top of the Deck Kickplate 23 is the Kickplate Support Bar 94. This bar is I″ tall and varies between 48 and 108″ long and is made of aluminum or other such suitable material. To the right of the Deck Kickplate is the Lower Telescopic Tube Section 56A-J. More information on the telescopic handrail system can be found in FIG. 11. Wrapped around the Lower Telescopic Tube Section 56 are two custom Kickplate Slider Brackets 31A-T. These Slider Brackets 31 are made from a material that provides a long life while combining properties that minimise friction during operation. These Brackets may be made from suitable engineering grade material via FDM printer, injection molding or they may be machined out of a single block of suitable material. Above the top Slider Bracket 31, 4 Handrail Endcaps can be seen 63. A more complete view and description of the Handrail Endcaps can be seen in FIGS. 45-50.

FIG. 9 shows a Horizontal Expanded View of the Lower Handrail Tube Section 56 and how it interacts with both the Kickplate Slider Brackets 31 and the Handrail Slider Assembly as seen in the upper and right portions of the drawing. Starting in the bottom left of the drawing we can see that there are two Kickplate Slider Brackets 31 (see FIG. 10), set apart a certain distance. Above diem we can see that the Deck Kickplates 23 (see FIG. 10) ends are in line with the edges of the Kickplate Slider Brackets, and above that we have the Kickplate Reinforcing Bar 94 (see FIG. 10).

Above this, there is a set of M8 hardware with the Nut listed as 99A-AN and the Kickplate Bolt 62A-AN. Moving right across the lower half of the drawing we can see that the extruded aluminum Lower Handrail Slider Tube 56 (see FIG. 10) is shown with a 11 mm thru hole listed as 71 visible. This hole is part of the Handrail Bolt Action Locking Assembly specifically featured in FIGS. 41 & 42. On the right-hand edge of the Lower Handrail Tube Section 56 there are 2 thru holes listed as 104. These holes are set at a location so that when the Lower Handrail Tube Section 56 is seated fully inside of the Slider Bracket Assembly Fitting 33, that the captive Nuts 99 and Handrail Slider Tube Bolts 34 will pass thru both sections holes 104 & 105 easily and secure the entire Handrail Assembly to the Handrail Slider Bracket Assembly mounter under the Deck Superstructure. Both the Slider Bracket Fitting 33 and Slider Bracket Shuttle 95 are made from either a high strength form of plastic via either an injection moulding process, FDM or other additive form of manufacturing as necessitated.

The Slider Bracket Shuttle 95 (see FIG. 10) has a minimum height to width ration of 1:1.5, with a minimum height to length ratio of 1.1. The Slider Bracket Shuttle 95 Attaches to the Slider Bracket Fitting 33 via a M8 recessed bolt that is tapped into the threaded far side of the Slider Bracket through the aligned holes of 106 & 107. This Slider Body Bolt 96 is made of Stainless steel and has an unthreaded portion allowing for the ease of rotation of 33. To the top right of the drawing we can see the Slider Bracket Mid Stop 8, which either a clastic or metal bracket made via either injection molding, FDM/additive manufacturing or milling and encompasses the Slider Bracket Tube 7 on 3 sides and varies in length between 12 and 24″ long. On either ends of the Slider Bracket Tube 7 there are a series of 2 thru drilled holes 97 that are positioned by first sliding both the Slider Bracket Mid Stop 8 and the Slider BracketEnd Stops 6 into position, marking and then drilling a 3 mm hole and then installing an appropriate length pop rivet. The Slider Bracket End Stops 6 are made the same manner as the Slider Bracket Mid Stops 8. It should be noted that the Slider Bracket Fitting 33, Shuttle 107 and Shuttle Bolt 98 will need to be assembled, tested and installed inside of the Slider Bracket Tube after it is attached to bottom of the Deck Superstructure FIG. 2 and before the Slider Bracket End Caps 6 are installed.

Now continuing to FIG. 10, which shows an isometric perspective of FIG. 9. The same items as discussed in FIG. 9 will again be highlighted here, but will not be explained again for brevity's sake, sufficed to say this perspective is included as way to better understand the relationships between the individual components. And while only I section of Lower Handrail Tube Section 56 is shown here, this method shall be applied to all 10 sections of Lower Handrail Tube across both Longitudinal faces of the deck: see FIGS. 11 & 12. The Arrow that is under 7 shows the direction of possible travel for the Slider Bracket 95.

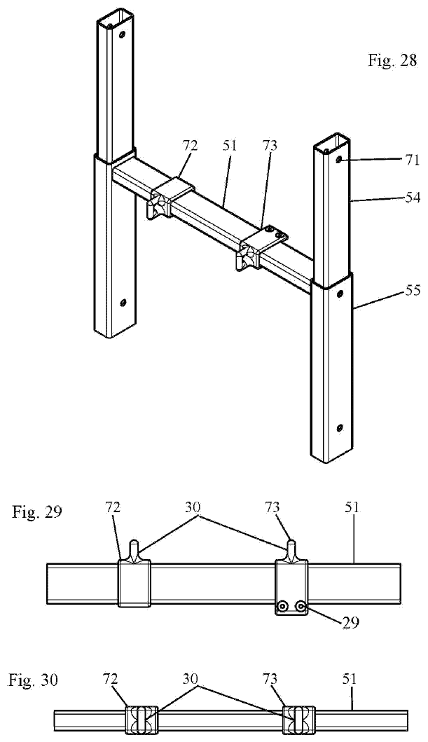

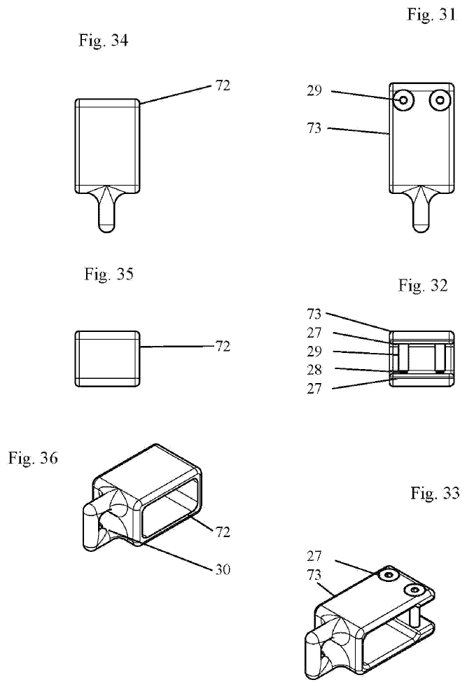

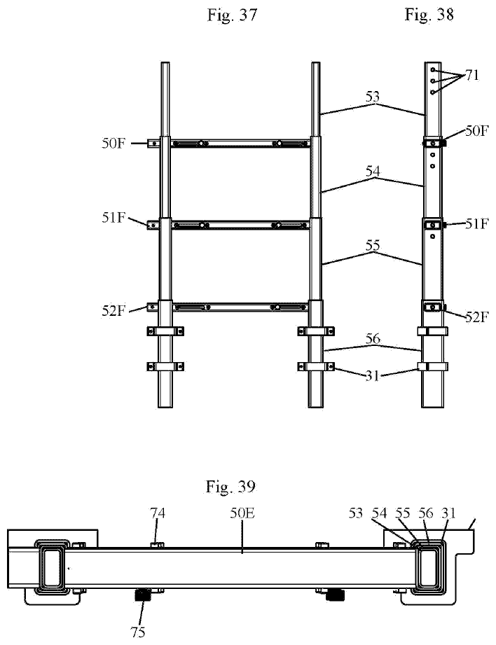

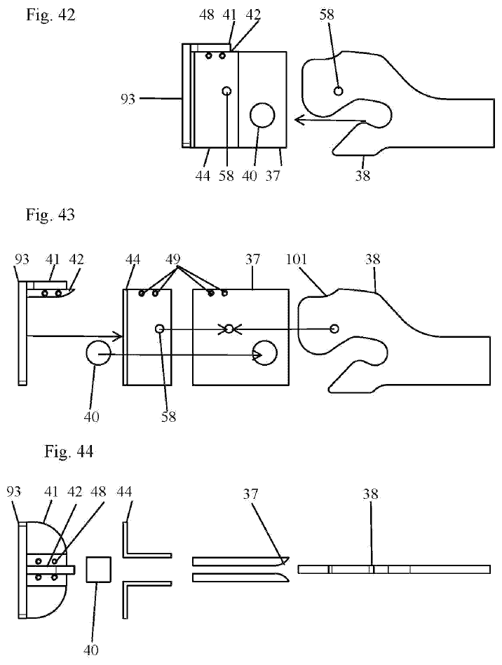

In FIG. 11 we can see the complete integration of both the Handrail, Handrail Slider Assemblies, and the Deck Superstructure FIG. 3. In this drawing the Front of the deck is that portion of the drawing in which the Handrail assembly is in the un-telescoped up right position and is closest to the left side of the page, with the rear position showing a raised and telescoped & folded position. Now talking about the front raised section of Handrail and starting from the top. The first thing to note is that both sections, that is front and rear sections of Handrail Assembly are identical structurally in design, installation, and use. However, one may notice that attached to the inside of the front handrail are items 58A-H, and 59, 60, and 61A-H respectively. Item 58 is a custom designed Handrail End Cap Securement Clip and will be covered more in FIGS. 26-30. Now referring to items 59-61, these 3 components comprise the Transverse Handrail Endcap system. In this drawing we will notice that they are folded and stowed against the inside of the front Handrail Assembly, however it should be noted that they may be mounted on the rear Handrail Assembly instead and that there are no differences in regards to how they would be installed or used. Note some drawings such as FIGS. 11 & 12 show the Eyelet 59 as being made out of a section of bent and welded 0.5″ aluminum round bar as an option instead of the FDM Eyelet shown in FIG. 45-50. Now talking about the Handrail Superstructure. As previous mentioned there are two different but identical front and rear Handrail assembly's, but the Handrail Superstructure, specifically refers to the extruded aluminum components that make up the vertical and horizontal components. The vertical components of the Handrail are made up of 4 sections of close tolerance telescopic rectangular tubing that all range in length from 12″ to 24″ and are as follows: the Lower Telescopic Tube Section 56, Lower-Mid Telescopic Tube Section 55, Upper-Mid Telescopic Tube Section 54, and Upper Telescopic Tube Section 53. The assembly and specifics of the vertical Handrail Superstructure components will be covered in detail in FIG. 37-39. The horizontal Handrail Superstructure components are once again made from extruded aluminum rectangle tubing. This tubing is 1″ high×2″ wide and has a nominal wall thickness of 0.125″ and shall all be thoroughly welded or affixed to the vertical Handrail components in such a way that they are fused together. The Handrail Top Cap 49 runs for a length between 48″ and 110″ and is securely welded or fastened to the Upper Telescopic Tube Section 53. For the following layers, 50, 51 and 52 the horizontal Handrail Superstructure components will be affixed 5.5 mm below the top of the adjoining vertical section and they are welded or fastened in the most secure manner possible. On the outside Edges stub sections of specifically varying lengths will be cut and installed in order to create a vertically aligned outer edge of the Handrail End Caps 50 (FIG. 39) countering the organic stagger created by telescopic tube sections 54, 55, 56. These Horizontal Stub Outs 50A & F, 51A & F and 52A & F, will be made and fashioned and secured like the same material was. and in the same manner as all other sections of the horizontal Handrail Superstructure and a more detailed view can be seen in FIG. 37. For Horizontal Handrail sections 50B & E, 51B & E and 52B & E specific face cuts will be needed prior to installation to install the Handrail Bolt Action Locking Pin Assay, with assembly specific details in FIGS. 41 and 42. On the rear handrail superstructure, horizontal handrail sections 50C & D, we can see the protrusions of 4 tie off brackets, which are covered in more detail in FIG. 28-36.

In FIG. 12 we see that both front and rear Handrail Assemblies are raised up in to the unfolded position, and that the Transverse Handrail Endcaps 59, 60, 61 have been swung out on both transverse ends and secured in to the opposing Handrail Endcaps 63 creating an aerial work platform basket. More detail on the Transverse Handrail Endcaps 59, 60, 61 can be found in FIGS. 47-52.

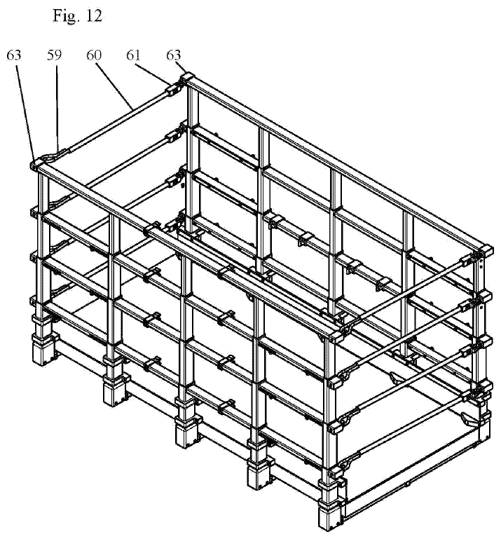

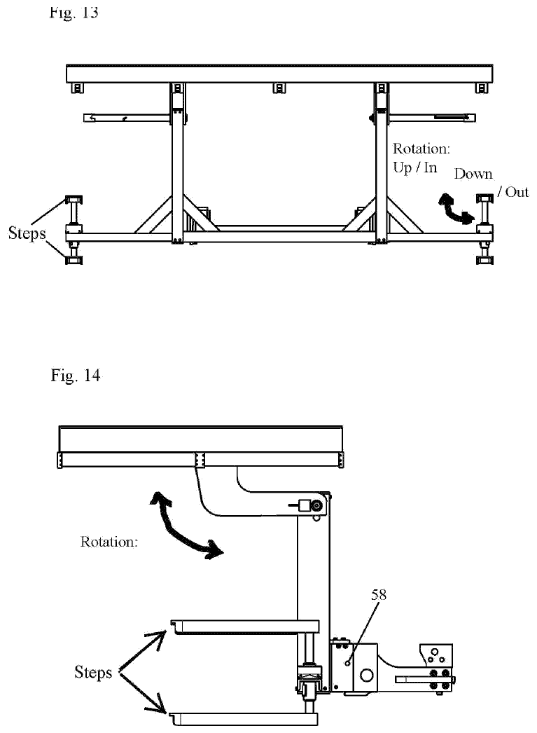

Moving on to FIG. 13. In this drawing we see the Deck Superstructure raised into the Up and locked position with the Step Assembly rotated into the down and locked position ready for use. More detailed drawing of the Step Assemblies are provided in FIG. 20-25. In this assembly, there are only 2 steps, however since the exact of Leg and Deck variable is unknown for every configuration based upon vehicle type and variance in mounting heights, it is therefore conceivable that while 2 are only shown here that the total installed steps may vary between I and 6 depending uncontrollable specifics at this point in time, and therefore the above variances should be included as key aspects of the unique invention.

Now looking at FIG. 14, we see the Deck still in the raised position, that the Step Assembly is still rotated out into the down and locked position, and that the Truck Mounting Bracket Assembly has been coupled together, with holes 58 now aligning together.

Moving on to FIG. 15, we can see the FIG. 14 now transposed in an isometric format to provide clarity on the interrelationship of components already and previously discussed in FIGS. 13 and 14.

Now discussing FIG. 16, here we see a partially exploded view of the Leg Assembly 12, Deck to Leg Bracket 25, Axle Bushing 119. An overview of the Leg Locking Pin Assembly 15, 10, 11 and the Upper 47 and Lower 46 Leg End Caps with Mounting Hardware. 74. In this drawing we can see that the Leg 12A has been removed from the entire assembly, in order to provide drawing specific detail, therefore, for please see FIGS. 13 and 14 for a general overview of the corporate placement details. Above the said Leg, we can seethe Upper Leg End Cap 47. This said cap is made of a hardened form of plastic via either the FDM, injection moulding or milling process and is designed with a tight fit inside of the top of the Leg 12. This cap is in such a way that it helps to dissipate the compressive, radial, and lateral loads from the axle mounting point further into said leg. The outside brim or edge of the said cap is sized to that a flange is produced and extends to the edge of the Legs 12 and meets diem flush. On the broad side of the said Upper Cap 47, there are 3 holes, two of the 109 are set at a place whereby the Leg Locking Pin Bolt 65 can pass thru. Hole 110 is sized so that the Axle 100 (not shown) can pass thru with support. Whereas on the narrow side located under the flange there are two tapped and threaded holes 108 that can receive a set of machine screws or other such threaded hardware 74 as seen on the Lower Leg End Cap 46. Under the Leg 12, the Lower Leg End Cap 46, is made in a like manner and design of the Upper Leg End Cap 47, albeit it is shorter in height with an internal height of 1″-0.2″ instead of the 6-10″ of the Upper Leg End Cap 47. Leading off to the left side of the Leg 12 we can see the Deck to Leg Bracket 25. In the complete design there are a total of 4 of these said brackets, with one on either side of each Leg 12. Said brackets are cut out of a single piece of aluminum at least 0.25″ thick and attaches to the longitudinal centreline of the Deck Superstructure via perimeter welding to the Inside Transverse Stringers 4A & C and is marked as point 112. Point 112 matches up with the deck centerline and is mounted flush. Against the top of the Inside Transverse Stringers 4A & C. These said brackets may or may not be notched around the Intermediate Longitudinal Stringers listed as 5A & B. At point 111 the aggregate height of bracket between 111 and 112 is equal to the height of the Inside Transverse Stringers 4 (FIG. 3). To the back right of the said bracket we can see the Axle Bushing 9 that is covered in greater detail in FIG. 7. In front of the Axle Bushing we have the Deck Locking Pin Assembly. 11 shows the Captive Body portion which has a minimum length of 15″ squared and a variable length between 6-26″ and is securely attached to the Deck to Leg Bracket 25 via a perimeter seam weld. The arrows provide directional assembly or rotational instructions that are possible.

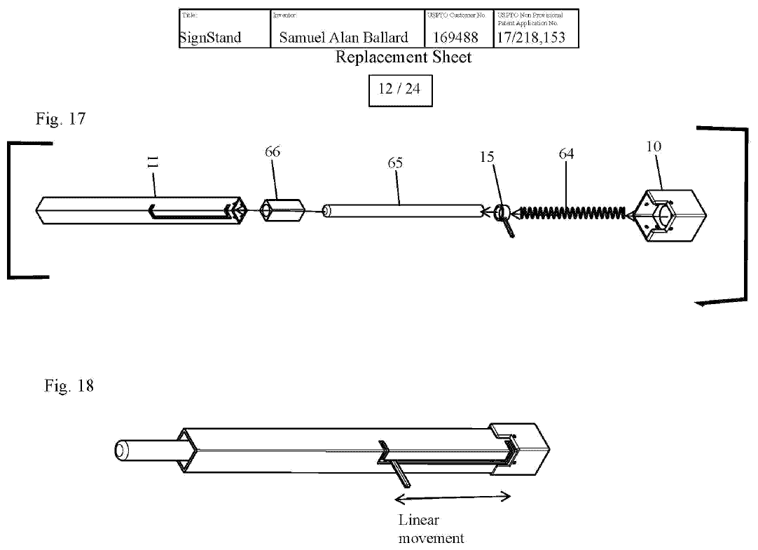

FIG. 17 shows an expanded component view of the Deck Locking Pin Assembly as featured in this unique invention. Working from left to right, the Captive Body 11A & B, these brackets are mirrors of each other and are installed on either side of the deck with one being attached to each Leg assembly 12. As mentioned in FIG. 16, the Captive Body portion which has a minimum height of 1.5″ squared and a variable length between 6-26″ and is securely attached to the Deck to Leg Bracket 25 via a perimeter seam weld. On two faces, those being the top and front facing face, there is a rabbit or channel cut into the material approximately 0.25″ wide and runs for a length of at least 4 inches. Next up 66, is a pressure fit Guide Bushing that provides two axis alignment for the Pin 65A & B. The Guide Bushing is made for a high strength long lasting low μ value plastic, that is either machined, FDM or additive manufactured or injection molded. The Pin 65 is a minimum of 0.5 inch in diameter and varies in length between 6-26″ long and has an outside end fillet of 0.25-0.5 times the diameter of the Pin. It is made of either aluminum or stainless steel and has a high visibility coating applies to the outside end to enable ease of detection for when the pin is sufficiently deployed for safety sake. Attached to the inboard end of the Pin 65, we have the Bolt 15A & B. the bolts are identical and are milled out of a block of metal or plastic, via an FDM or additive manufacturing process or injection moulding. The Bolt attaches to the Pin 65, via either or a combination of compression fitting, mechanical fastening or adhesive compound or weld thus creating a strong bonded component. When fastened together, the Bolt 15 and the Pin 65 make a Bolt Action Subcomponent that when installed inside of the Captive Body 11 and will slide up and down/back and forward & in and out and rotate 90 degrees up and down inside of the rabbited channel creating a bolt action style assembly. Placed between the Bolt 15 and Locking Pin End Cap 10 is a compression spring 64 of a specific size and compressive force. This said spring ensures drat should the bolt slip out of the unlocked position, or out of the locked position then the expansive force of the spring will ensure that the preferred state of the Bolt Action Subcomponent is in the locked, forward or out position, ensuring the Deck Assembly remains secured at all times. The Locking Pin End Cap 10 is a custom designed component that is made of a hardened form of plastic via either the FDM, injection moulding or milling process and is designed to be secured via combination of a partial compression tit and a series of 3 mm pop rivets securing the said endcap to the Captive Body 11. Note the arrows show working assembly process.

Quickly moving on to FIG. 18 we have an enlarged isometric profile view of the Deck Locking Pin Assembly, as it would appear fully assembled, with the left side edge of the Captive Body 11 being welded to the outside faces of Deck to Leg Brackets 25. Note: the arrows indicate the level of linear travel possible.

FIG. 19 shows an isometric profile from a lower viewpoint. Starting in from the left, we see the Step Outrigger 14 that runs out from the Leg 12 to the Axle Hub 18A & B. The face on the left side of the Step Outrigger is securely welded to the leg to prevent movement. The Step Outrigger is made from a section of extruded aluminum C channel that has a minimum height to width ratio of 1:3 and has a variable length between 12-24″. As we look at the actual steps 13A-D, we can see that the steps are made of the same size and thickness aluminum C channel as the Outrigger and has a rounded nose. Underneath of the Steps, we have the Step Support Brackets 67A-D. The said brackets, are cut of aluminum bar and have a height equal to the inside channel rise minus the radius and are securely welded to the steps. Set into the Step and Step Support Bracket at a distance at least equal to ½ that of the width, and set along the center line of the step, a hole at least I″ in diameter is made into which the axle 16A & B is press fit and welded. The Axle 16 being at least I″ in diameter with a minimum wall thickness of 0.25″ and a variable length between 6-48″. Attached to the Axle 16, is the Axle Collar 17A & B. The Axle Collar is made of a high strength and durable plastic that is manufactured via FDM, additive manufacturing or injection moulding and made to be tightly tit over the axle until it reaches a certain distance at which point the axle is marked and then thru drilled with a total of 4 holes, in sets of 2 together and perpendicular from each other. Once the Axle 16 is drilled the Axle Collar 17 is reinstalled and then bolts are threaded thru and are used to secure the Axle collar into position see FIGS. 21 and 24 for more details. Attached to the outboard side of the Step Outrigger 14 is the Rotator Block 18. Like the Axle Collar 17, the rotator block is made from, a similar form of compatible material in a similar fashion See FIGS. 22 & 23 for more details.

FIG. 20 provides an enlarged frontal aspect view of FIG. 19 to better show the complexity of the unique design for clarity.

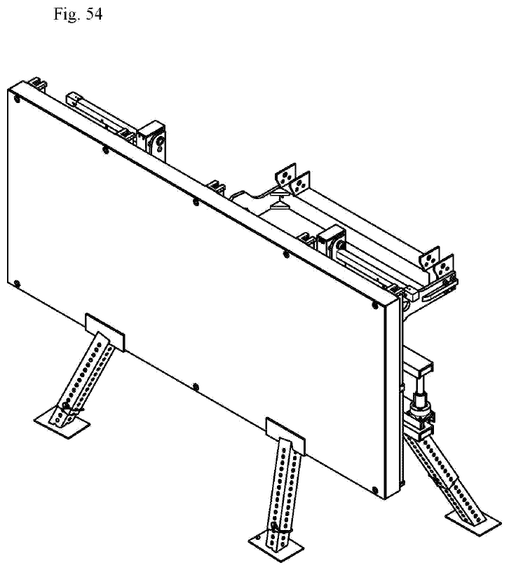

As we look at FIG. 21, we can see the same assembly first observed in FIG. 19, but now from a Transverse Side on view. First, we notice that the Steps 13 are the same length, however that the Lower Step 13B has a hole 70 present that is centrally located along the vertical axis a certain distance in from the outside edge. This hole is designed to receive a 0.5″ Alignment Pin that is part of the Removable Telescoping Leg Assembly featured in FIG. 52-57. If we look just below the Rotator Block 18 and Step Outrigger 14, we can see the lower half of the Step Collar and the holes for 2 of the 4 securement bolts 118.

Moving on to FIG. 22 we see a Rotator Block 18 in an isometric sectional cut thru marked as B-B which is derived the said block in FIG. 23. The purpose of this drawing is to illustrate features 117, 116 and 115. 117 shows the recessed Locking Slit that secures the Axle Collar Extrusion 114 on the Axle Collar 17 and prevents said collar from accidently rotating or moving whence it is placed in either the up and locked/stowed position or the down and rotated out position as seen in FIG. 14. Whereas 116 shows the thru channel that allows the Axle Collar Extrusion 114 to pass thru both the Rotator Block 18 and corresponding hole marked as 113 on the top of the face of the Step Outrigger 14. Continuing 69 shows a hole for one of the 4 M4 screws that are used to secure the Rotator Block 18 to the Step Outrigger 14.

FIG. 23 contains an isometric expanded view of the Step Assembly in more detail with the top step/steps 13A omitted to provide a larger view. Moving down the right-hand side of the page we can see the Rotator Block 18 first that provides the sectional view marked B-B for FIG. 22. The Rotator Block in this drawing has been rotated 90 degrees around the vertical axis in order to provide a better view and understanding of the breadth, width, and depth of the Locking Slit 117. Towards the bottom of the said block, we can see the reliefs and holes created to allow the securement screws 69 to be installed. Below the Rotator Block 18, we see the expose face of the Step Outrigger 14, with a hole marked as 113 that is located and sized in such a manner that the Axle Collar 17 and Axle Collar Extrusions 114 can clear the new sides of the Step Outrigger 14 with minimal play. Adjacent to the said hole 113 there are 4 holes marked out as 113. These holes are threaded to receive an M4 screw that is first inserted thru the top face of the Rotator Block 18 and is marked as 69.

Continuing down we see the Axle 16 with the Axle Collar 17 mounted together, with the annotations A-A which is the original view for the cross-sectional view in FIG. 24. Below this, we have the lower step 13B. All the Steps have a tread brite aluminum diamond plate finish that is cut to fit and then securely welded or fastened to the top of the step in such a manner as they become one. Below the Step, is the Step Support Bracket 67 that is shown with dashed lines illustrating the non-visible edges for context. The fingers 103 may vary in length, size, or presence, and in either case variance there in should be considered as original to the design and functionality of the Step and Step Support Bracket as originally intended by the inventor. More details can be found in FIG. 19.

FIG. 24 shows the cross-sectional view A-A with its origins in FIG. 23, with the intent to show the necessary profile of the Axle Collar 17 and the necessary holes for installing bolts. Note Mounting hardware is not shown for clarity but assumed to be in the final design for this to work properly. We can see that the Axle Collar 17 being located a certain distance up from the bottom of the Axle 16 is placed in position and then there are 4 holes 57 marked in total, with only 2 being shown in this orientation. Once marked, the Axle Collar is slid away and then the holed are drilled thru the axle. Once the Axle Collar is slid back into position the hardware 68 is inserted (not shown) and it is screwed into the threads visible 43032 on the far side of the collar. More details can be found in FIG. 19.

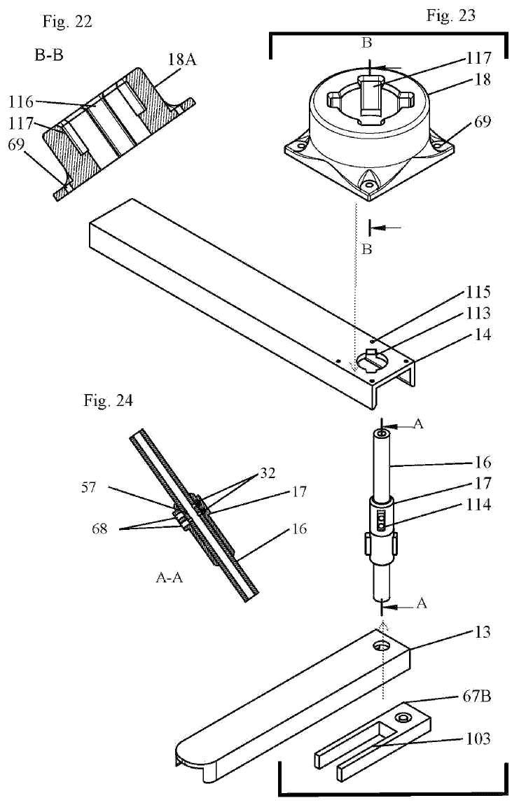

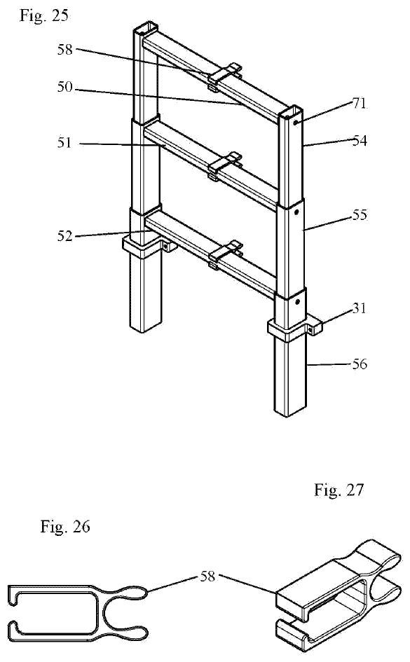

Moving on, FIG. 25 shows an enlarged sectional view of the Transverse End Cap Handrail Securement Clip originally featured in FIG. 12. This Securement Clip 58A-F is clipped on to the horizontal handrails 50, 51, 52 and is easily removed or replaced as necessary. The said clip is custom designed for this task and is made from plastic. These clips will be made via either an additive manufacturing & FDM process, or injection moulding to produce apart that is strong, has mild ultraviolet and chemical resistance and is aesthetically pleasing.

FIG. 26 shows the Securement Clips first mentioned in FIG. 25 from a side on perspective. The C portion that is on the right of said clip and secures the Transverse End Cap Handrail (see FIG. 12) is designed to receive and secure a round tube I″ in diameter. On the left side of said clip the rectangular inner dimensions are the same as the horizontal handrail section pieces 49-52 which is 1″ high and 2″ wide.

FIG. 27 shows the Securement Clip 58 first mentioned in FIG. 25 from an isometric on perspective. From this perspective we can see that the overall width of the clip is proportional to the height of the inside rectangle dimensions and that is approximately 25 mm wide. We can also see that all exterior the edges between two or more faces have been smoothed over with a 2 mm radius fillet.

FIG. 28 shows a section of handrail that can be found initially in FIG. 12. On the intermediate Horizontal Handrail piece 51 there can be seen two options for the installed Tie Off Brackets 72 and 73. Option 72 is a permanently installed Slider Tie Off Bracket that is installed prior to the Horizontal Handrail piece 51 being welded to the adjacent sections of vertically Retractable Telescoping Handrail 55. Whereas, option 73 represents a replaceable Clip-On Style Bracket that employs the use of two bolts to prevent coming off when used. Both Tie Off Brackets 72, 73 except for the stainless-steel hardware in the latter bracket are made of the same material in a similar manner and are about the same size. Both brackets are derivatives of the Transverse Handrail End Cap Bracket 63 that can be seen in FIGS. 12 & 47. The rectangular inner dimensions are the same as the horizontal handrail section pieces 49-52 which are 1″ high and 2″ wide. Protruding forward from the we can see the Eyelet 30, which has a 20 mm hole and a median eyelet thickness of 15 mm. Both the Tie Off brackets 72, 73 and the Transverse Handrail End Cap Bracket 63 are made from a high performance plastic suitable for the application and may contain composite reinforcing fiber such as carbon fiber, fiber glass and or Kevlar as examples and are made via either an additive manufacturing/FDM, or injection moulded process.

FIG. 29 shows the Tie Off Brackets 72, 73 and the Horizontal Handrail piece 51 from a top down perspective. Looking at the permanently installed Slider Tie Off Bracket 72, we can see that the bracket is only slightly larger 5-10 mm in most directions than the bar that it is mounted on. However, if we look at the Clip-On Style Bracket 73, we can see that it protrudes further back than the previously mentioned slider bracket and that there are 2 flat head screws flush mounted in the top face 29.

FIG. 30 is a front facing view of FIG. 29 showing that both the eyelets on either the Slider Tie Off Bracket 72 or Clip-On Style Bracket 73 are the same. This view also shows the overall heights of the bracket, in that they only protrude between 5-10 mm above or below the Horizontal Handrail piece 51.

FIG. 31 shows the Clip-On Style Bracket 73 from the top with the flat head screws 29 present.

FIG. 32 shows the Clip-On Style Bracket 73 from FIG. 31 in a rear-view perspective where we can see the feeder ramps 27 as two dark horizontal lines, and the flathead recessed screws 29, along with the captive recessed bolts 28.

FIG. 33 we can see the Clip-On Style Bracket 73 from FIG. 31 in a frontal isometric projection in order to provide clarity on the overall shape of the bracket in particular the Eyelet 30, and feeder ramps 27 along with the positioning of the recessed flathead screw 29 and nut 28.

Moving on to FIG. 34 we can see a top down view of Slider Tie Off Bracket 72 seen previously in FIG. 29.

FIG. 35 shows a rear on view of Slider Tie Off Bracket 72, as seen previously in FIG. 29 and in contrast to the Clip-On Style Bracket 73 there is no hardware and the back is completely enclosed.

FIG. 36 shows an isometric frontal view of the Slider Tie Off Bracket 72, as seen previously in FIG. 29, and as mentioned in FIG. 35 the back is shown enclosed and there is a clearly defined interior channel for the Horizontal Handrail piece 51 to pass through. Also, we notice that the Eyelet 30 is shown protruding from the front in an identical manner to that in FIG. 33.

Moving on to FIG. 37 we can see that there is partial handrail section that for clarity has been extracted out of the complete Handrail Assembly initially seen in FIG. 12. Looking at the left side of the handrail section we can see the Horizontal Stub Outs 50F, 51F and 52F, these stub Horizontal Stub Outs are made from the same material as all the other Horizontal Handrail pieces including 50E, 51E & 52E that are shown. These bars are made from extruded aluminum rectangle tube that is 1″×2″ and has a minimum wall thickness of 0.125″. Referring now to the Horizontal Stub Outs, they are cut in a manner that they increase in length as they rise up in order to offset the vertical Telescoping Tube size reduction gap and therefore leave a flush outside edge as seen in FIG. 11. These Horizontal Stub Outs 50F, 51F & 52F, like the Horizontal Handrail pieces 50-52 are securely, and fully welded to the vertical Telescopic Tube Sections 53-56 at exactly 5 mm below the top of said section. The said telescopic Tube Sections are designed to have as minimal slop as possible in between the sizes, however sections 53-55 shall be completely wrapped on all exterior vertical faces with UHMW adhesive tape to both reduce friction, metal wear/fatigue but also buffer out any size variance that might be present. Note: UHMW tape is not shown but is assumed to have been installed to all vertical Telescopic Tube Sections 53-55. Note the Kickplate Slider Brackets 31 are shown as an identifiable reference point only.

FIG. 38 shows the same handrail section as seen in FIG. 37, but this time from a transverse side on perspective. In this drawing we can see that there are a series of holes marked as 71. These holes are 11 mm in diameter and are centrally located along the vertical axis of the all vertical Telescopic Tube Sections 53-56. These holes spaced at a certain distance apart allow the entire Handrail Superstructure & Assembly to be securely locked in either the un-telescoped/up position or in the down and telescoped position as seen in FIG. 11. The Handrail Bolt Action Locking Pin Assembly will be covered in more detail in FIGS. 40 & 41. Note the Kickplate Slider Brackets 31 are shown as an identifiable reference point only.

Moving on, FIG. 39 provides a top down view of the same handrail section as seen in FIG. 37, but from a new angle. From this position we can see how the 4 vertical Telescopic Tube Sections 53-56 all telescope inside of each other, and that all of the Horizontal Stub Outs 50-52A & F along with the Horizontal Handrail pieces 50-52 all vertically aligned one on top of another with minimum offset. Also, we can see the Burled Knob 75 and Machine Screws 74 holding the Handrail Bolt Action Locking Pin Assembly which will be covered in more detail in FIGS. 37 & 38. Note the Kickplate Slider Brackets 31 are shown as an identifiable reference point only.

Looking at FIG. 40 here we can see a frontal view of a section of handrail like as seen in FIGS. 12 & 34. On the left see a section of vertical Telescopic Tube Section 54, 55, 56 and abutting this there is a section of Horizontal Handrail 50, 51 & 52B & E, for these sections the right side of the said Horizontal Handrail has a mirror image cut as is shown here on the left side of the bar. The round holes are either 0.25″ or 7 mm in diameter and a cut in a way that either a ¼-20 or M6 screw can be passed thru to secure the Locking Pin Body 24 (see FIG. 38) to the Horizontal Handrail. Face Cut 26 is made via using a custom-made router template, CNC Laser table or other form of CNC milling. Hole 10, is tapped and treaded into the Locking Pin 77 (see FIG. 41) and receives the Buried Knob 75.

FIG. 41 shows an expanded view of an entire Handrail Bolt Action Locking Assembly starting on the left we can see a section of vertical Telescopic Tube Sections 53-56 that is representative of any single section or all 4 sections telescoped in together. In the center of the said tube section a hole 71 is made that is a certain distance from the top of the tube to which the Locking Pin 77 can slide through so that the bevelled nose clears the far hole. The Locking Pin 77 is a minimum of 1.0 mm in diameter and has a beveled nose whose radii is equal to the radius of the pin. The said Locking Pin also varies in length between 50 mm an 200 mm in length with a threaded hole perpendicular to the length of the pin some 10 mm from the far end opposite the bevelled nose 10. To the right of the Locking Pin 77, the Locking Pin Body 76 is found. The said body is made of PETG, ABS, ASA, PA-K or other forms of suitable weather resistant plastic and is made either via the additive material/FDM or injection moulding and post moulding milling process. The said body is sizes so that it is has the same outer dimensions as the inner dimension of the Horizontal Handrail Tubing sections 50-52. The front two threaded holes 24 are placed in such a manner that when installed inside of the Horizontal Handrail sections 50-52 the nose of the Locking Pin Body 76 is no closer than 20 mm from the adjacent vertical Handrail Tubing Section 53-56, with the front threaded hole no closer than 25 mm to the same said vertical section. Behind the Pin 77 in the rear of the Body 76 is a compression spring 20 of sufficient size and strength that the natural home position of the pin will always be in the locked forward position. After the Spring 20 and then Pin 77 are installed into the body 76 which is inserted into the end of the Horizontal Handrail Section 50-52, the Burled Knob 75 is threaded into the end of the Pin 77 with an appropriate amount of liquid thread fastener to prevent accidental loosening. After this the screws 74 are inserted into the appropriate holes 14624 and tightened. When opening the bolt, there is a lip 43378 inside of the Locking Pin Body 76 that is used to catch and temporally arrest the forward force of the compression spring. This lip is designed in such a way that any substantial bump or vibration will cause the Pin 77 and attached Burled. Knob 75 to rotate back up and slam forward into the locked position. This method is identical for all Handrail Locking Pin Assemblies. Note arrow shows the locations of pieces for assembly.

FIG. 42 brings us back to the Truck Mounting Bracket Assembly and moving from left to right first we come to The Female Coupler which is connected to the Legs 12 (Not shown: See FIGS. 5-7) and the Bi-Metal Backer Plate 93. This said plate is a minimum of 6″ wide×6″ Height and 0.25″ thick. This Backer Plate 93 is capable of being welded to aluminum and steel simultaneously without creating a Galvanic reaction. At the top to the immediate right, we have the Top Cap 41 which is secured via 4 bolts 48 (Not shown: See FIG. 5-7) to the Feeder Ramps 37. The Top Cap is about 3″×6″ with rounded corners and sits aside the Bi-Metal Bracket 93. Below the Top Cap is the Lipping Ramp 42 that is edge welded to the Top cap and helps keep the Male Side Connector Bracket 38 in position.

Welded to the Bi-Metal plate 93 are two steel feeder ramps 37 that are mirror images of each other. They are about 6″ squared and feature a bevelled leading edge (See FIG. 41) to help guide the male end into a coupling position. These Feeder Ramps 37 are secured via welding in such a manner that the do not interfere with the positioning of other pieces, 38, 41, 42, 44 but are close enough together to prevent rack or wobble in the coupled joint but loose enough to allow easy coupling of the male and female components. On either side of the Feeder Ramps 37 are two L Brackets 44 that are welded to both the Bi-Metal Plate 93 and the Feeder Ramps providing reinforcement for the bracket. Approximately ¼ way back from the leading bevelled edge on the Feeder Ramps 37 and about ⅓ of the way up from the bottom edge on there is a 1.5″ hole designed to receive a 1.5″ Loading Pin 40. Further to the right again we can see the Male Side Connector Bracket 38A showing the outline of the bracket, and in particular the Inverse Lipping Ramp 101 cut to match the profiled Lipping Ramp 42 on the Female side, with the corresponding Cotter Pin Hole 58 just below. In the middle we can see the Loading Pin Cut Out feature 102 (FIG. 43) which ramps up and over the Loading Pin 40 providing three axis securement Further right again and sitting on top of the Male Side Connector Bracket 38A The Male Side Connector Bracket 38 is between 12″ and 30″ long, at least 8″ high and runs all the way back to the Frame Rail Box Beam 45 at the back (Not shown: See FIG. 5-7). Note arrows show the locations of pieces for assembly.

FIG. 43 we can see and expanded side view of all the components listed in FIG. 42. Under the Top Cap 41, we can see the Lipping Ramp 42, and the horizontal threaded holes 49. On the far right on the nose of the Male Coupler point 101 is a negative impression found on the Lipping Ramp 42 mounted below the Top Cap 41.

FIG. 44 is a bottom up view of the expanded component view found in FIG. 43 and from this perspective we can first see the bolt holes 48 in the Top Cap 41 that secures it to the Feeder Ramps 37. Moving further right we can see the bevelled leading edge on the Feeder Ramps 37 that helps to guide and align the Male side Couple brackets with the Female side.

Now moving on to a different place in the design we see FIG. 45 that shows a isometric view of the complete Transverse End Cap Handrail System which is made of 4 different components starting from the left: The Handrail Endcap 63 which is additive manufactured/FDM printed with the Handrail Eyelet 59 attached, followed by the aluminum Round Tube 60 and ending out up with the Locking Claw 61. The 6061 aluminum Round Tube has a minimum diameter of 0.75″ with a minimum wall thickness of 0.125″ and a variable length between 18″ and 46″ in length. In the face opposite the eyelet 30 on the Handrail End Cap 63 we have a countersunk Flat Head Screw 79 hole to secure the Transverse Handrail End Cap to the Horizontal Stub Outs 50, 51, 52A or F. Located on the topside of the Handrail Eyelet 59 are two MS or greater weld nuts 80 that are recessed into the vertical extrusion on the top and bottom of said eyelet. On the other end in the Locking Claw 61, there is a Spring Pin 82 that is used to keep the Transverse Handrail Assembly in the closed and locked position attached to the other opposing Handrail Endcap 63. The said spring pin has a minimum operating length of 0.75″ and a minimum pin diameter of 0.125″. The flat head screw 81, has a minimum size of MS with a minimum length of 35 mm and goes from the top side to the bottom side of the Locking Claw 61 where it screws into a recessed weld nut 80 in a similar fashion as seen in the Handrail Eyelet 59. Note: all The Flat Head Screws 81, and Weld Nuts 80 are secured with a dab of thread lock at installation to prevent unwanted loosening.

Looking at FIG. 46, we can see the same assembly found in FIG. 45 however in an inside view that would be see from either across the deck of from on top of the deck inside of the basket looking off the side see FIG. 12. Looking at the Locking Claw 61 we can see that there is a recessed channel 98 that is cut into the face that allows the Locking Claw 61 to slide along the linear axis of the Round Tube 60 a certain distance Weld Nut 80 and Flat Head screw 81 on the other side prevent further outward movement. The inverted arrows on the left side of the Locking Claw 61 show the possible level of linear travel.

In FIG. 47 we can see the same assembly found in FIG. 45 however in a vertical orientation, and from a top down perspective. In this position, we can easier see the Locking Claw 61 Flat Head screw 81 that attaches the said locking claw to the Compression Spring 19. From this perspective we can also get a better view of the recessed Weld Nuts 80 that are set into the top extrusion on the Handrail Eyelet 59. We can also see that the inside diameter of the eye is a minimum of 20 mm, with a minimum possible external eye diameter of 40 mm.

FIG. 48 shows a partial cross-section of the Locking Claw 61 and Round Tube 60, as well as Flat Head screw 81 that attaches the said locking claw to the Compression Spring 19 and the receiving Weld Nut 80.

In FIG. 49, we can see a partial cross-section of the Handrail End Cap 63, Horizontal Stub Outs 50F, 51F & 52F, countersunk Flat Head Screw 79, Handrail Eyelet 59, and Round Tube 60, as well as Flat Head screw 84 and receiving Weld Nut 80. We also get a good look at the 20 mm inside diameter of the Handrail End Cap Eye 30, along with across sectional view of the actual Handrail Eyelet 59.

Looking at FIG. 50, we can see the same assembly found in FIG. 45 however in a vertical orientation and from a transverse side on perspective. In this position we can see the flat head screw 81 that is inside of a slider recess 83. This screw is attached to attached to the end of an Extension Spring 19 (see FIG. 48) both inside of the aluminum Round Tube 60 as well as inside of the Locking Claw 61 as seen in FIG. 45. This spring allows the Locking Claw 61 a range of horizontal travel for the along the same axis of the Round Tube 60, making it easier to latch and unlatch the claw from the receiving Handrail End Cap 63 mounted on the other handrail. While at the same time assuring that the handrail is usually in a state of compression and is always pulling inwards.

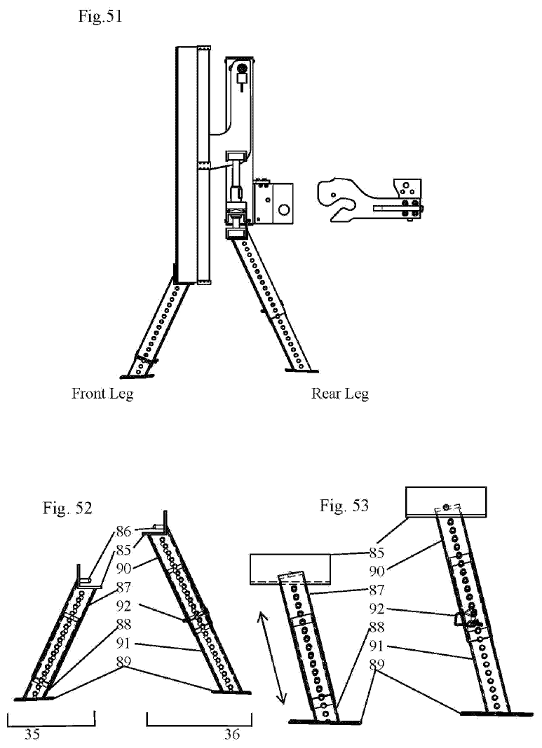

Moving on to the Removable Telescoping Legs FIG. 51 we can see a general side on view of the unique inventions with the front and rear Removable Telescoping Legs installed. This drawing is intended to provide an overview only.

FIG. 52 in this drawing we can see the Front 35 and Rear 36 Removable Telescoping Legs, in the same position as in FIG. 51 just without the general side on view of the unique invention. Here we can see dial both sections are almost identical in design, just with the Rear Section 36 being longer than the front 35. Starting from the bottom, 89 is the foot pad that is welded on the lower sections of the Telespar tubing for form a footing. This said footing is a minimum of 4″ wide by 6″ long with a pad thickness of 0.125″. On top of this are the lower extension sections that a made from steel Telespar or Unistrut. These sections 88 and 91 are made from 2.25″ OD square material and have a leg variance between 12″ and 36″ depending on the mounting vehicle frame height and other considerations.

Above this Lower Tube is the Upper Tube, sections 87 & 90 which are made from 2.5″ OD square tube steel Telespar or Unistrut material with a variable length between 12″ and 36″ which allows the Lower Tube sections to easily telescope in and out of the Upper Tube sections. Item 92 represents an off the shelf 3″×0.25-0.5″ thick cotter pin that is used to set the leg height. On top of and securely welded to the Upper Tubes 87 & 90 and set at a certain angle and offset the 3″ Angle Iron 85 acts as a support bracket. Set at some height up and along the angle iron 80, a round 0.5″ pin is placed that gets inserted into the receiving holes on the front of the deck and back lower step as seen in 21, and 51-53.

FIG. 53 shows both front 35 and rear 36 sections from a front on perspective for the purpose of illustrating the offset metered angle that is imputed into the legs in order to keep the freestanding body of the invention as see in FIG. 48 stable. Note: nonvisible edges are shown is a dashed line, which is used to try and provide 3-dimensional clarity and context to the drawing Also to the left side of the Front Legs (FIG. 51) there is a set of directional arrows showing the slider movement off the legs.

FIG. 54 shows the Removable Telescoping Legs attached to the general view of the unique invention from an offset frontal view. Here we see that the Front Leg sections 35 pins have been inserted into the Handrail Locking Sleeves 9J & G as seen in FIG. 2, and that the Rear Leg sections 36 have been inserted into the Lower Step 13B & D receiving pin hole 70 as seen in FIGS. 19 & 20.

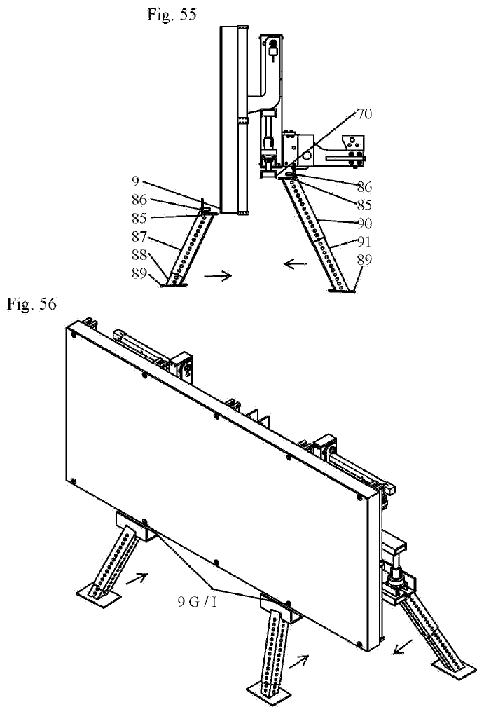

FIG. 55 provides a general side on view of the unique inventions with the front and rear Removable Telescoping Legs uninstalled with the arrows pointing forward towards instillation. This drawing is intended to provide an overview only context only.

FIG. 56 shows the Removable Telescoping Legs unattached to the general view of the unique invention from an offset frontal view. Here we see that the Front Leg sections 35 pins have not been inserted into the Handrail Locking Sleeves 9J & G as seen in FIG. 50, and that the Rear Leg sections 36 have not been inserted into the Lower Steps 13B & D receiving pin hole 70 as seen in FIGS. 19 & 20 and indicated by the arrows.

What is claimed is:

1. A unique aerial work platform that is also capable of being used in a dual capacity as a push bumper for straightening signs/signposts or clearing debris, vehicles, or other blocking items off the travelled right of way, or else being used a portable work bench.
a. That this invention is mounted on the front of a vehicle and is attached to said vehicle via a custom quick connect coupler system with one half attached to the vehicle and the second half attached to the aerial work platform lower superstructure.
b. That when detached from the vehicle the invention is capable of being supported by removable telescoping supports capable of holding it at set height for a period of time.
c. That there are unique steps that are capable of being rotated into a deployable position by passing the axle thru the step outrigger while rotating and raising or lowering them.

2. That the deck superstructure shall rotate around a central point co located towards the top of the legs on the lower aerial work platform superstructure, with a spacing of specific size capable of receiving a retractable telescoping handrail of other such required items.

3. That the handrails shall be of a fully telescopic variety, and capable of being stowed below the deck while being ANSI/OSHA compliant,
a. That there are 5 vertical handrails sections, with 3 intermediate horizontal sections with I top full-length handrail cap on either long side of the platform.
b. That the handrails are secured into position via the use of locking pins that are of the bolt action variety and spring assisted and mounted internally inside of the intermediate horizontal handrail sections in such a manner that they are capable of passing thru all four sections of the vertical handrails when telescoped in.
c. That there are 8 end cap handrails capable of folding into and clipping into a sliding clip capable of holding said end cap handrail securely in a stowed position while in transit.
d. That the fall protection restraints are attached to the rear handrail in such a fashion that they are either permanently installed or removeable with the use of a safety bolt.
